(19) United States
(12) Patent Application Publication
(10) Pub. No.: US 2021/0209523 A1
(43) Pub. Date: Jul. 8, 2021

(54) SYSTEM AND METHOD FOR END-TO-END CONTACTLESS DINING EXPERIENCE AND MANAGEMENT

(71) Applicant: RockSpoon, Inc., San Jose, CA (US)

(72) Inventor: Nagib Georges Mimassi, Palo Alto, CA (US)

(21) Appl. No.: 17/216,360

(22) Filed: Mar. 29, 2021

Related U.S. Application Data
(63) Continuation-in-part of application No. 17/037,200, filed on Sep. 29, 2020.
Application No. 17/037,200 is a continuation-in-part of application No. 16/993,488, filed on Aug. 14, 2020.
(60) Provisional application No. 63/143,326, filed on Jan. 29, 2021.
(60) Provisional application No. 62/956,289, filed on Jan. 1, 2020.
(60) Provisional application No. 62/956,293, filed on Jan. 1, 2020.

(51) Int. Cl. G06Q 10/02; G06Q 20/10; G06Q 30/06; G06Q 30/02; G06Q 50/12

(52) U.S. Cl. CPC G06Q 10/02; G06Q 20/102; G06Q 50/12; G06Q 30/0207; G06Q 30/0635

(57) ABSTRACT

A system and method for end-to-end contactless dining experience and management. A server is communicatively coupled with Internet-connected devices such as a customer's mobile device or a website and facilitates restaurant reservations, preordering of consumables, bill splitting, and payments all via the customer's preferred method of execution. The server further uses advanced algorithms to predict optimal arrival times and menu choices based on a variety of restaurant, customer, and locality data hosted in a database. The server enables a full contactless dine-in dining experience for a hygiene-conscience society.

### BACKGROUND

### Field of the Art

The disclosure relates to the computerized restaurant management systems, and more particularly to the field of dynamic table turn-time estimation, waitlist management, reservation allocation, and bill paying.

### Discussion of the State of the Art

Waitlists at restaurants are primitive and inefficient, being based on a standard queuing system established as customers arrive at a restaurant and request a table, and often being done using pen and paper. As tables become available, the next group of customers on the list gets seated, which often leads to inefficient allocations of groups with table sizes. Exceptions are performed manually, based on the restaurant staffs personal knowledge of available tables. Reservations at restaurants are likewise primitive and inefficient, being based entirely on the restaurant staffs personal knowledge of expected restaurant activity, and often being done as a simple pen and paper list of customers arriving at given times. Expected wait times and availability of reservations depend in part on table turn-times, which are based on a fixed average of table turnovers in a given period of time. This leads to inaccurate wait time estimation and potential reservation conflicts or overlap.

Furthermore, dining experiences in a post-COVID-19 world should be as contactless as possible. It is well-known that smartphones, cash, and other devices such as point-of-sale devices carry a host of harmful bacteria and viruses. While, sanitizing point-of-sale devices is becoming commonplace, reliance on employees to do a sufficient job is introducing unnecessary risk. There is currently no end-to-end solution for a contactless dining experience.

What is needed is a system and method that allows for a contactless dining experience for the customer and management of that experience on the restaurant back-end.

### SUMMARY

Accordingly, the inventor has conceived and reduced to practice, A system and method for end-to-end contactless dining experience and management. A server is communicatively coupled with Internet-connected devices such as a customer's mobile device or a website and facilitates restaurant reservations, preordering of consumables, bill splitting, and payments all via the customer's preferred method of execution. The server further uses advanced algorithms to predict optimal arrival times and menu choices based on a variety of restaurant, customer, and locality data hosted in a database. The server enables a full contactless dine-in dining experience for a hygiene-conscience society.

According to a first preferred embodiment, a system for end-to-end contactless dining experience and management is disclosed, comprising: a database, wherein the database comprises a customer profile and meal preparation times; and a restaurant server comprising a first plurality of programming instructions stored on a memory of, and operating on a processor of, a computing device, wherein the first plurality of programming instructions, when operating on the processor, causes the processor to: receive a customer's request for a reservation; receive an order associated with the reservation; calculate an earliest arrival time for the customer, wherein the earliest arrival time is based on a scheduling algorithm, a waitlist algorithm, the profile of the customer, and the meal preparation time of the order; send the earliest arrival time to the customer; receive an acknowledgement confirming the earliest arrival time; send customized instructions to restaurant staff, wherein the customized instructions detail exact times when to prepare each item in the order; receive a check-in acknowledge from the customer; send an alert to wait staff, the alert instructing wait staff to seat the customer; receive a request to pay for the order; and facilitate payment of the order.

According to a second preferred embodiment, a method for end-to-end contactless dining experience and management, comprising the steps of: receiving a customer's request for a reservation; receiving an order associated with the reservation; calculating an earliest arrival time for the customer, wherein the earliest arrival time is based on a scheduling algorithm, a waitlist algorithm, the profile of the customer, and the meal preparation time of the order; sending the earliest arrival time to the customer; receiving an acknowledgement confirming the earliest arrival time; sending customized instructions to restaurant staff, wherein the customized instructions detail exact times when to prepare each item in the order; receiving a check-in acknowledge from the customer; sending an alert to wait staff, the alert instructing wait staff to seat the customer; receiving a request to pay for the order; and facilitating payment of the order.

According to various embodiments; the database further comprises staff data, inventory data, sales data, and locality data, wherein the locality data is updated by real-time feeds; the restaurant server facilitates bill splitting if there are two or more customers associated with the order; the system and method further comprising an orders module, comprising a second plurality of programming instructions stored in the memory and operating on the processor, wherein the second plurality of programming instructions, when operating on the processor, causes the computer system to: offer discounts on preferred items, wherein preferred items are based in part on the customer's profile, the inventory data, and the sales data.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram representation of a business establishment including an embodiment of a food order management system.

FIG. 2 is a block diagram representation of an embodiment of a food order management system.

FIG. 3 is an illustration of an example of a food preparation display.

FIG. 4 is an illustration of an example of a food order pick-up display.

FIG. 5 is an illustration of an example of a food packaging display.

FIG. 6 is an illustration of an example of a delivery order pick-up display.

FIG. 7 is a flow diagram representation of an example of a method of managing preparation of food items in a food order using an embodiment of the food order management system.

FIG. 8A is a flow diagram representation of an example of a method of managing delivery of a food order illustrating the flow from receipt to generation of an estimated delivery time;

FIG. 8B is a flow diagram representation of an example of a method of managing delivery of a food order illustrating the flow from displaying a food order through updating an estimated food packaging time with a food item database;

FIG. 9 is a block diagram showing an exemplary system architecture of a system for dynamic reservation and waitlist management using precision table turn-time analysis.

FIG. 10 is a flow diagram showing an exemplary algorithm for implementation of a dynamic table turn-time analyzer.

FIG. 11 is a flow diagram showing an exemplary algorithm for implementation of a dynamic reservation manager.

FIG. 12 is a flow diagram showing an exemplary algorithm for implementation of a dynamic waitlist manager.

FIG. 13 is a block diagram representation of an end-to-end contactless dining experience and management system.

FIG. 14 is a block diagram representation of a customer using a mobile device with an end-to-end contactless dining experience application.

FIG. 15 is a block diagram representation of a first customer in a party using a first mobile device with an end-to-end contactless dining experience application for bill splitting.

FIG. 16 is a block diagram representation of a second customer in the same party using a second mobile device with an end-to-end contactless dining experience application for bill splitting.

FIG. 17 is a flow diagram showing an exemplary algorithm for implementation of an end-to-end contactless dining experience and management system driven smartphone application.

FIG. 18 is a block diagram illustrating an exemplary hardware architecture of a computing device.

FIG. 19 is a block diagram illustrating an exemplary logical architecture for a client device.

FIG. 20 is a block diagram showing an exemplary architectural arrangement of clients, servers, and external services. and

FIG. 21 is another block diagram illustrating an exemplary hardware architecture of a computing device.

### DETAILED DESCRIPTION

The inventor has conceived and reduced to practice a system and method for end-to-end contactless dining experience and management. A server is communicatively coupled with Internet-connected devices such as a customer's mobile device or a website and facilitates restaurant reservations, preordering of consumables, bill splitting, and payments all via the customer's preferred method of execution. The server further uses advanced algorithms to predict optimal arrival times and menu choices based on a variety of restaurant, customer, and locality data hosted in a database. The server enables a full contactless dine-in dining experience for a hygiene-conscience society.

According to one preferred embodiment, the dining experience logistics on the customer end is completed fully on the customer's smartphone via an application. However, other embodiments utilizing a website are anticipated and said website would be accessible on a variety of computing devices including the customer's smartphone. An additional embodiment is also anticipated where the steps and methods from the smartphone application and/or website are converted to a Dual-Tone Multifrequency (DTMF) menu for an additional contactless dining experience. Behind all three anticipated embodiments (smartphone or any mobile device, website, and DTMF signals) there may be a server which facilitates and manages the functions and features of the smartphone application, website, and DTMF calls, and a database which stores customer and restaurant information. The server having a customer interaction module which may stream mobile applications from the server, act as a mobile application's back-end, the server may also host one or more websites, and lastly the server may comprise DTMF functions to facilitate DTMF transactions.

The server comprises a reservation module, an orders module, a payment module, and a customer interaction module. The customer interaction module facilitates the mechanism by which customers interact with the restaurant server. That may be a mobile application, a website, or a DTMF phone conversation. The reservations, orders, and payment modules all operate through the customer interaction module.

The reservations module handles making, changing, and canceling reservations. As such the reservations module manages seating arrangements, waitlists, individuals, large parties, customer preferences, predicts table turn times, notifications to patron mobile devices, among other features described herein. The reservations module may institute a floating minimum for reservations based on capacity. Some restaurants may employ premium seating for which the reservations module will offer an upsell to the patron. The reservations module uses a variety of data to make predictions for the management of the waitlist and reservations. For example, if the customer is using a GPS equipped device, the reservations module may access the GPS data of that device and other patron devices to enhance predictions and manage logistics restaurant wide. Other data used in predictions may include current and future restaurant staff, wherein the staff data includes performance metrics and shift times, as well as customer data comprising historical data such as length of visit, food ordered, favorite servers, party size, and other patron associations.

The orders module presents menu options and allows patrons to make an order. Orders may be placed for pickup, delivery, or dine-in. The orders module works in tandem with the reservations module where by reservations may be altered such that the order is hot and ready as soon as the customer arrives and is seated at their table. The orders module may comprise dynamic pricing algorithms that take into account patron data such as returning patrons or customer preferences and may further incentivize patrons with discounts on slow days or on soon-to-be-expired inventory or other logistical and strategic considerations known in the art.

The payment module receives party (names, pictures, stored payment information, etc.) information from the reservations module and order information for the party from the orders module in order to present payment options to at least one member of the party, or some members of the party, or all members of the party. Assigning different patrons as members of the same party many be accomplished by the reservations module when each member preorders his or her food via his or her respective device. Wait staff may check-in patrons as they arrive and assign them to a party. GPS, Wi-Fi, or other wireless technologies may be used to identify the members of a party. according to one embodiment, the reservations module generates a unique alphanumeric code or QR code in some embodiments, that allows other patrons to enter on their device or scan on their device which automatically assigns them to the same party. Party members will have payment options that include bill splitting where each member of the party may drag and drop a picture of the food item ordered to a section of the screen where their picture or name is thus assigning payment of that food item to that member. The drag and drop option mentioned above may be presented on just one member's smartphone application or if some or all members of the party have the application and are registered to that party may also be presented with the drag and drop option. Unclaimed food items will be split amongst each member of the party by default or if two or more members each dragged that food item to their name or picture each member will be presented with an option to split between the specific members of the party. Taxes and tips are separate to each member of the party. If a member of the party does not have a smart device or chooses not to participate with the application, the restaurant may provide a device on which the member may complete his or her payment. One embodiment allows for one member's mobile device to be shared amongst the group, whereby a first member completes their portion of the bill splitting and is prompted to pass the device to a second member such that the second member completes their portion of the bill splitting and that bill paying is complete, once all members have completed his or her portion of the bill splitting. One aspect of the previous embodiment is a feature whereby a member may be skipped on the shared member's mobile device because the skipped member will complete his or her portion of the bill paying on his or her own device. Identifying information on the members during the bill splitting process may be gathered from stored information on the restaurant's database or from the user profiles on the smart device.

The database stores information such as patron data, staff information, inventory information, sales data, meal preparation times, and the physical layout of tables and furniture. Patron data comprises names, number of visits, family members, contact information, payment information, food preferences, dietary restrictions, physical handicaps, age, and may further be linked to social media accounts. Staff information includes performance metrics such as order accuracy, patron ratings, order completion times, etc. other staff information may comprise salary information, scheduling data, home address, contact information, shift preferences, vacation time, etc. Inventory information comprises stocked food items and is updated when orders are placed (sales data) and further informs the orders and reservations modules. The orders and reservations modules use the inventory information from the database for decisions regarding micro-deals and discounts presented to customers and predictions of food availability, table turn times, capacity, order timeliness and completeness. Information in the database may further be supplemented by real time data such as weather, social media, and news where in this supplemental information may be used by the modules to generate better predictions. According to one embodiment, the database and restaurant server are cloud based services.

An example of the system as a whole is as follows: the server receives a customer's request for a reservation followed by an order for food, drink, and consumables associated with the reservation. Prediction algorithms and supplemental data (scheduling algorithm, a waitlist algorithm, a profile of the customer, and a meal preparation time of the order, traffic, weather, etc) calculate the earliest and most optimal time for the customer to arrive such that the customer spends the least amount of time waiting. This including being seated and having the order served. The server will send the earliest arrival time to the customer and if the customer accepts, typically by responding to a push notification, an SMS or other message, a button in a mobile application, or other communication vehicles described herein, an acknowledgement confirming the earliest arrival time will be received by the server. The server, using the order information, estimated travel time of the customer, and the scheduling and waitlist algorithms will send customized instructions to restaurant staff, wherein the customized instructions detail exact times when to prepare each item in the order. These customized instructions may be displayed on a monitor connected to the server, or some other device such as a point-of-sale device within the same network of the server. Other embodiments may send the customized instructions to a separate network than that which the server resides. Upon the customer arriving at the restaurant, he or she will check-in (on the app, or through a messaging services, etc.) and the server will receive an acknowledgment. The server will send an alert to wait staff, the alert instructing wait staff to seat the customer. The alert may be sent via the customer interactions module, wherein outward-facing network protocols of the module such as messaging and push notifications may be used to send to specific wait staff. Other embodiments anticipate alerts to wait staff displaying on point-of-sale devices or one or more monitors communicatively attached to the server. Additional consumables may be ordered through the via the customer interaction module which communicatively couples to one or more mobile devices, websites, or phone services. According to one embodiment using a mobile application, when the customer is ready to leave, the customer may get on the application and select the pay option. The server will receive a request to pay for the order and facilitate payment of the order. Should there be more than one customer associated with an order, the server will facilitate bill splitting between them.

Described below are additional anticipated embodiments comprising a food order management system. A food order management system generally coordinates the preparation and delivery of food orders at a business establishment. Examples of business establishments include, but are not limited to, a restaurant, a food delivery service, and a combination restaurant/food delivery service. The business establishment includes a food preparation area, a food order pick-up area, a food packaging area, a delivery order pick-up area, and a dine-in seating area. A customer of the business establishment is provided with an option of selecting one or more food items from a menu to place a food order. Food items in the food order are prepared in the food preparation area and the completed food orders are placed in the food order pick-up area. When the food order is for a dine-in customer, a waiter/waitress picks up the completed food order from the food order pick-up area to deliver to the customer in the dine-in seating area.

Upon the receipt of a food order from a dine-in customer, the food order management system coordinates the preparation of the food items in the food order in the food preparation area and generates a predicted food order ready time. The predicted food order ready time specifies when the prepared food order is expected to be placed in the food order pick-up area. Providing a predicted food order ready time at the time a food order is received may enable a waiter/waitress to inform a dine-in customer of when they can expect to receive the food items in their food order.

When the food order is received for delivery, food packaging personnel pick up the completed food orders from the food order pick-up area, package the food items in the food order in the food packaging area, and place the packaged food order in the delivery order pick-up area. Delivery personnel pick up the packaged food order from the delivery order pick-up area for delivery to a food order delivery destination.

Upon the receipt of a food order for delivery, the food order management system coordinates the preparation of the food items in the food order in the food preparation area, generates a predicted food order ready time, coordinates the packaging of the food items in the food order, generates a predicted packaged food order ready time, coordinates the delivery of the food order to the food order delivery destination, and generates a predicted food order delivery time. The predicted food order ready time specifies when the prepared food order is expected to be placed in the food order pick-up area for pick-up. The predicted food order ready time provides food packaging personnel with notice regarding when the food order will be available to be picked up from the food order pick-up area for packaging in the food packaging area. The predicted packaged food order ready time specifies when the packaged food order is expected to be placed in the delivery order pick-up area for pick-up by delivery personnel. The predicted food order delivery time specifies when the food order is expected to be delivered to the food order delivery destination.

The food order management system updates the predicted food order ready time based on the actual food item preparation time taken by food preparation personnel to prepare each of the food items in the food order in the food preparation area. The food order management system updates the predicted packaged food order ready time based on one or more of the actual food item preparation time taken by food preparation personnel to prepare each of the food items in the food order in the food preparation area and the actual time taken by food packaging personnel to package each of the food items in the food order in the food packaging area. The food order management system updates the predicted food order delivery time based on one or more of the actual food item preparation time taken by food preparation personnel to prepare each of the food items in the food order in the food preparation area, the actual time taken by food packaging personnel to package each of the food items in the food order in the food packaging area, and changes in delivery route specific data associated with a delivery route for delivering the food order to the food order delivery destination.

According to one embodiment, a system and method for dynamic table turn-time estimation, waitlist management, reservation allocation, and bill paying is disclosed. The systems may operate independently to improve a single aspect of restaurant operations, or may be combined such that data from one system feeds into another to further improve operations. The system for turn-table estimation incorporates data from numerous restaurant sources such as restaurant history data, customer history data, reservation context data, and kitchen operations, etc., and analyzes it to accurately predict table turn-times, dynamically adjusting the predictions on a table-by-table basis as the data changes. The system for reservation management similarly ingests data from numerous restaurant sources such as restaurant history data, customer history data, special request data, and existing table-by-table reservation data, and analyzes it to predict table availability, assign reservations on a table-by-table basis, and dynamically re-allocate table-by-table reservations as necessary to improve restaurant operations. The system for waitlist management likewise ingests data such as customer location, traffic information, and table turn-times, to dynamically predict estimated wait times, maximize table occupancy, assign waitlist spots to customers who have not yet arrived at the restaurant, and re-order the waitlist as customers arrive and/or leave the restaurant.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

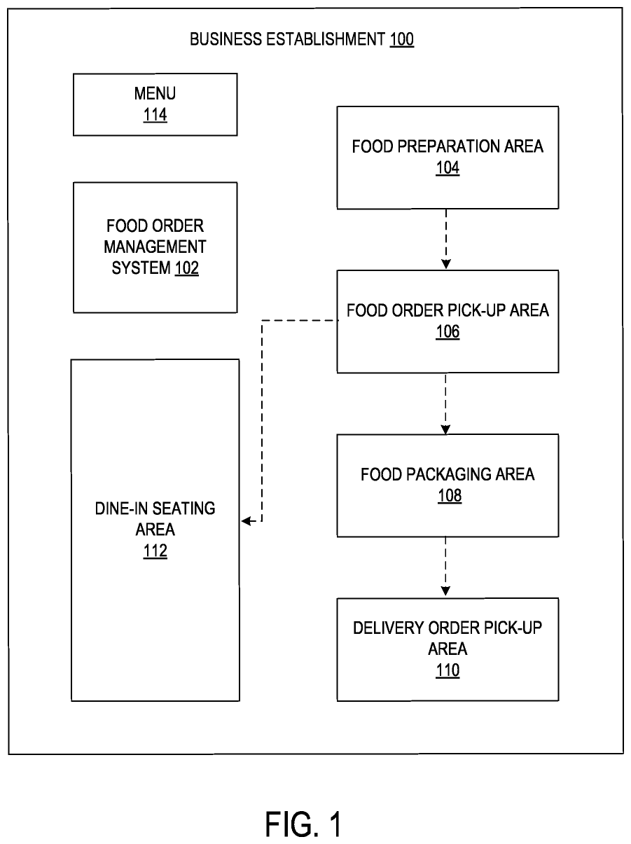

Referring to FIG. 1, a block diagram representation of a business establishment 100 including an embodiment of a food order management system 102 is shown. Examples of business establishments 100 include, but are not limited to, a restaurant, a food delivery service, and a combination restaurant/food delivery service. In an embodiment, the business establishment 100 includes a food preparation area 104, a food order pick-up area 106, a food packaging area 108, a delivery order pick-up area 110, and a dine-in seating area 112. While the food preparation area 104, the food order pick-up area 106, the food packaging area 108, the delivery order pick-up area 110, and the dine-in seating area 112 are shown as being in different areas within the business establishment 100, one or more of the described areas may be integrated into a single area or may occupy overlapping areas in the business establishment 100. Different embodiments of business establishments 100 may include one or more of the food preparation area 104, the food order pick-up area 106, the food packaging area 108, the delivery order pick-up area 110, and the dine-in seating area 112. The business establishment 100 may include additional areas that facilitate the operation of the business establishment 100.

The business establishment 100 includes a menu 114 with a listing of a plurality of different food items that are available for order at the business establishment 100. A customer of the business establishment 100 is provided with the option of selecting one or more of the food items from the menu 114 to place a food order. In an embodiment, the food order management system 102 is configured to receive food orders entered manually by business establishment personnel via a food order management system input device. In an embodiment, the food order management system 102 is configured to receive food orders electronically via a food order management system network interface. In an embodiment, the food order management system 102 is configured to received food orders entered manually by business establishment personnel via a food order management system input device and electronically via a food order management system network interface.

Food items in a food order are prepared in the food preparation area 104 and the completed food orders are placed in the food order pick-up area 106. Upon the receipt of a food order from a dine-in customer, the food order management system 102 coordinates the preparation of the food items in the food order in the food preparation area 104 and generates a predicted food order ready time. Different food items in the food order may have different food item preparation times. The predicted food order ready time specifies when the prepared food order is expected to be placed in the food order pick-up area 106. In an embodiment, the food order management system 102 updates the predicted food order ready time based on the actual food item preparation time taken by food preparation personnel to prepare each of the food items in the food order in the food preparation area 104. Providing a predicted food order ready time at the time a food order is received may enable a waiter/waitress to inform a dine-in customer of when they can expect to receive the food items in their food order.

When a food order is received for delivery, the food items in the food order are prepared in the food order preparation area 104 and the completed food orders are placed in the food order pick-up area 106. Food packaging personnel pick up the complete food orders from the food order pick-up area 106 for packaging in the food packaging area 108. The packaged food orders are placed in the delivery order pick-up area 110. Delivery personnel pick up the packaged food from the delivery order pick-up area 110 for delivery to a food order delivery destination.

Upon the receipt of a food order for delivery, the food order management system 102 coordinates the preparation of the food items in the food order in the food preparation area 104, generates a predicted food order ready time, coordinates the packaging of the food items in the food order, generates a predicted packaged food order ready time, coordinates the delivery of the food order to the food order delivery destination, and generates a predicted food order delivery time. Different food items in the food order may have different food item preparation times and/or different food item packaging times.

The predicted food order ready time specifies when the prepared food order is expected to be placed in the food order pick-up area 106 for pick-up. The predicted food order ready time provides food packaging personnel with notice regarding when the food order will be available to be picked up from the food order pick-up area 106 for packaging in the food packaging area 108. The predicted packaged food order ready time specifies when the packaged food order is expected to be placed in the delivery order pick-up area 110 for pick-up by delivery personnel. The predicted food order delivery time specifies when the food order is expected to be delivered to the food order delivery destination. The food order management system 102 generates the predicted food order delivery time based on delivery route specific data associated with the delivery route.

In an embodiment, the food order management system 102 updates the predicted food order ready time based on the actual food item preparation time taken by food preparation personnel to prepare each of the food items the food order in the food preparation area 104. In an embodiment, the food order management system 102 updates the predicted packaged food order ready time based on one or more of the actual food item preparation time taken by food preparation personnel to prepare each of the food items the food order in the food preparation area 104 and the actual food item packaging time taken by food packaging personnel to package each of the food items in the food order in the food packaging area 108. In an embodiment, the food order management system 102 updates the predicted food order delivery time based on one or more of the actual food item preparation time taken by food preparation personnel to prepare each of the food items the food order in the food preparation area 104, the actual food item packaging time taken by food packaging personnel to package each of the food items in the food order in the food packaging area 108, and changes in delivery route specific data associated with the delivery route associated with delivering the food order to the food order delivery destination.

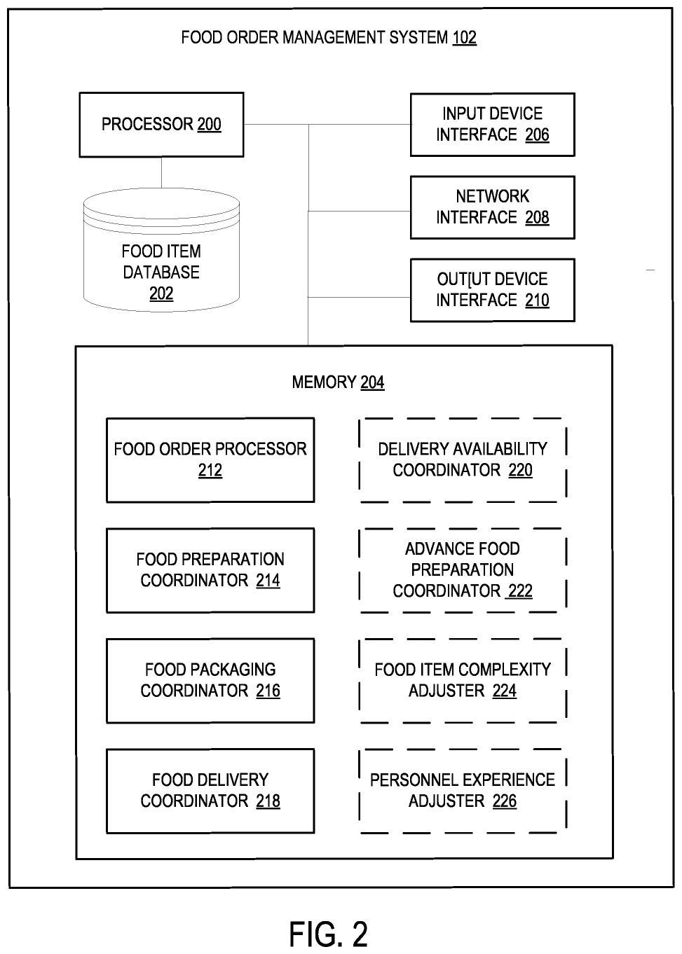

Referring to FIG. 2, a block diagram representation of an embodiment of a food order management system 102 is shown. In an embodiment the food order management system 102 includes a processor 200, a food item database 202, and a memory 204, at least one input device interface 206, at least one network interface 208, and at least one output device interface 210. The processor 200 is communicatively coupled to the food items database 202, the memory 204, the at least one input device interface 206, the at least one network interface 208, and the at least one output interface 210.

In an embodiment, the food order management system 102 is configured to be communicatively coupled to a food preparation display in the food preparation area 104, a food order pick-up display in the food order pick-up area 106, a food packaging display in the food packaging area 108, and a delivery order pick-up display in the delivery order pick-up area 110 via the at least one output interface 210. In an embodiment, the at least one input device interface 206 is configured to be communicatively coupled one or more of a keyboard, a touchscreen, and a mouse. The food order management system 102 may include additional components that facilitate the operation of the food order management system 102. The food order management system 102 may include fewer than the described components.

In an embodiment the food order management system 102 is a centralized system. In an embodiment, the food order management system 102 is a distributed system. In an embodiment, the food item database 202 is disposed locally at the business establishment 100. In an embodiment, the food items database 202 is disposed at a location remote from the business establishment 100. In an embodiment, the food item database 202 is a component of the food order management system 102. In an embodiment, the food item database 202 is an independent database that is not a component of the food order management system 102. The food item database 202 is configured to store an estimated food item preparation time and an estimated food item packaging time for each food item on the menu 114.

In an embodiment, a food order processor 212, a food preparation coordinator 214, a food packaging coordinator 216, and a food delivery coordinator 218 are stored in the memory 204. In an embodiment, one or more of a delivery order availability coordinator 220, an advance food preparation coordinator 222, a food item complexity adjustor 224, and a personnel experience adjustor 226 are stored in the memory 204. Additional components may be stored in the memory 204 that facilitate the operation of the food order management system 102.

The food order processor 212 receives food orders that are placed at the food order management system 102 for processing. The business establishment 100 may provide one or more different options to a customer for placing a food order including food items selected from the menu 114.

In an embodiment, customers are provided with the option of placing food orders with business establishment personnel. The business establishment personnel manually enter the received food orders into the food order management system 102 via one or more input devices that are communicatively coupled to the at least one input device interface 206. For example, a customer may wish to dine at the business establishment 100. After the customer is seated in the dine-in seating area 112, the customer places a food order including food items selected from the menu 114 with business establishment personnel. An example of business establishment personnel is a waiter or a waitress. The waiter or waitress enters the food order into the food order management system 102. The food order is received by the food order processor 212.

In an embodiment, a customer is provided with the option of calling the business establishment 100 and placing food orders with business establishment personnel. The business establishment personnel manually enter the received food orders into the food order management system 102 via one or more input devices that are communicatively coupled to the at least one input device interface 206. For example, a customer may call the business establishment 100 to place a food order with food items selected from the menu 114 for delivery with business establishment personnel. The food order is received by the food order processor 212.

In an embodiment, a customer is provided with the option of placing food orders with food items selected from the menu 114 via a drive thru interface. For example, a customer may place a food order with food items selected from the menu 114 for pick-up at a drive thru window. Business establishment personnel that staff the drive thru manually enter the received food orders into the food order management system 102 via one or more input devices that are communicatively coupled to the at least one input device interface 206. The food order is received by the food order processor 212.

In an embodiment, a customer is provided with the option of placing a food order with food items selected from the menu 114 electronically via an establishment web site or online portal using a customer electronic device. The food order management system 102 is configured to be communicatively coupled to the establishment web site or online portal. Food orders placed via the establishment web site or online portal are received by the food order management system 102 via the at least one network interface 208. Examples of customer electronic devices that may be used to access the establishment web site or online portal to place a food order include, but are not limited to, a mobile computing device, a cell phone, a desktop computer, and a tablet. The food order is received by the food order processor 212.

In an embodiment, a customer is provided with the option of placing a food order with food items selected from the menu 114 electronically via a kiosk located within the business establishment 100. The food order management system 102 is configured to be communicatively coupled to the kiosk via one of the at least one network interface 208 or the at least one input device interface 206. The food order is received by the food order processor 212.

In an embodiment, each of the tables in the dine-in seating area 112 is equipped with a table order placement device. When a customer is seated at a table in the dine-in seating area 112, the customer is provided with the option of placing a food order with food items selected from the menu 114 electronically via the table order placement device. The food order management system 102 is configured to be communicatively coupled to each of the table order placement devices via the at least one network interface 208 or the at least one input device interface 206. The food order is received by the food order processor 212.

While a number of different options for placing a food order that is received by the food order management system 102 have been described, alternative mechanisms for placing of a food order may be used.

Upon the receipt of a food order at the food order management system 102, the food order processor 212 identifies the food items in the food order and determines whether the food order is a designated for dine-in at the business establishment 100 or for delivery to a food order delivery destination. If the food order is designated for delivery, the food order processor 212 identifies the food order delivery destination for the food order. The food order processor 212 provides the food order, the identified food items to the food order, and the designation of the food order as being for dine-in or for delivery to the food preparation coordinator 214.

Different food items often have different food item preparation times. The estimated food item preparation time for a food item is an estimate of the amount of time that it takes food preparation personnel in the food preparation area 104 to prepare the food item. The estimated food item preparation time for each food item on the menu 114 is stored in the food item database 202. In an embodiment, the estimated food item preparation time for a food item is based on an analysis of historical food item preparation times for that food item by the food order management system 102. The food order management system 102 tracks the actual food item preparation time that it takes to prepare the food item in the food preparation area 104 and updates the estimated food item preparation time for that food item in the food item database 202 in accordance with the tracked actual food item preparation times. In an embodiment, the food management system 102 employs time estimation algorithms to generate the estimated food item preparation times for the different food items and stores the generated estimated food item preparation times in the food item database 202.

The food preparation coordinator 214 receives the food order, the identified food items in the food order, and the designation of the food order as being for dine-in or for delivery from the food order processor 212. The food preparation coordinator 214 accesses the food item database 202 and retrieves the estimated food item preparation time for each of the food items in the food order from the food item database 202. The food preparation coordinator 214 generates an estimated food order preparation time for the food order based on the retrieved estimated food item preparation times for each of the food items in the food order.

The food preparation coordinator 214 identifies the earliest food preparation time available to prepare the food items in the food order in the food preparation area 104. The food preparation coordinator 214 tracks the number of pending food orders for dine-in and for delivery that are awaiting preparation or are scheduled to be prepared in the food preparation area 104. The food preparation coordinator 214 identifies the earliest available food order preparation time for the food order based on the number of pending food orders and the status of the pending food orders. The food preparation coordinator 214 assigns the identified food order preparation time to the food order. The food preparation coordinator 214 generates a predicted food order ready time for the food order based on the assigned food preparation time and the estimated food order preparation time.

In an embodiment, the food order management system 102 coordinates the preparation of the food items in the food preparation area 104 sequentially. In an embodiment, the food order management system 102 coordinates a parallel preparation of one or more food items in the food order in the food preparation area 104. The food preparation coordinator 214 identifies the earliest available food preparation times for each food item in the food order and assigns each of food items to individual food preparation times. The food preparation coordinator 214 generates the predicted food order ready time for the food order based on the food preparation times assigned to individual food items in the food order and the estimated food item preparation time for each food item in the food order.

The food preparation coordinator 214 tracks the actual food item food preparation time for the preparation of each of the food items in the food order as well as the food preparation times associated other food orders that are scheduled for preparation in the food preparation area 104. The food preparation coordinator 214 updates the predicted food order ready time based on one or both of the actual food item food preparation time for the preparation of each of the food items in the food order and the actual food order preparation times associated other food orders that are scheduled for preparation in the food preparation area 104. The food order management system 102 updates the estimated food item preparation times in the food item database 202 for each of the food items in the food order based on the actual food item preparation times tracked by the food preparation coordinator 214.

In an embodiment, the food order management system 102 is communicatively coupled to cameras and/or other types of sensors located in the food preparation area 104 via the at least one input device interface 206. The cameras and/or other types of sensors provide feedback to the food preparation coordinator 214 regarding the actual food item preparation time of food items in the food preparation area.

In an embodiment, the food order management system 102 includes a food item complexity adjustor 224. The food preparation coordinator 214 provides the food item complexity adjuster 224 with the food order, the food items in the food order, the estimated food item preparation times for each food item in the food order, the estimated food order preparation time for the food order, and the predicted food order ready time for the food order. The food item complexity adjuster 224 identifies a food item complexity factor associated with each of the food items in the food order. The food item complexity factor for each food items identifies whether additional food item preparation time is needed for specific food items in the food order. For example, a food item having a routine complexity may have a food item complexity factor of one and a food item that is relatively more complex may have a food item complexity factor of two.

The food item complexity adjuster 224 adjusts the estimated food item preparation times for each of the food items in the food order by the food item complexity factor, generates an adjusted estimated food order preparation time based on the adjusted estimated food item preparations times for each of the food items in the food order. The food item complexity adjuster 224 updates the predicted food order ready time based on the adjusted estimated food order preparation time. The food item complexity adjuster 224 provides the food preparation coordinator 214 with the adjusted estimated food item preparation times for each of the food items in the food order, the adjusted estimated food order preparation time, and the updated predicted food order ready time.

In an embodiment, the food order management system 102 includes a personnel experience adjustor 226. The food preparation coordinator 214 provides the personnel experience adjustor 226 with the food order, the food items in the food order, the estimated food item preparation times for each food item in the food order, the estimated food order preparation time for the food order, and the predicted food order ready time. The personnel experience adjustor 226 assigns specific food preparation personnel to prepare specific food items in the food order. The personnel experience adjustor 226 identifies a personnel skill factor for each of the food preparation personnel assigned to prepare each food item in the food order. For example, a relatively more experienced food preparation personnel may have a personnel skill factor of 0.75 while a novice food preparation personnel may have a personnel skill factor of 1.5.

The personnel experience adjustor 226 adjusts the estimated food item preparation times for each of the food items in the food order by the personnel skill factor associated with the food preparation personnel assigned to prepare the food item and generates an adjusted estimated food item preparation time for each food item in the food order. The personnel experience adjustor 226 uses the adjusted estimated food item preparation times for the food items in the food order to generate an adjusted estimated food order preparation time and uses the adjusted estimated food order preparation time to generate an adjusted predicted food order ready time. The personnel experience adjustor 226 provides the food preparation coordinator 214 with the adjusted estimated food item preparation times for each of the food items in the food order, the adjusted estimated food order preparation time, and the updated predicted food order ready time to the food preparation coordinator 214.

If the food items in the food order were designated for a dine-in customer, the processor 200 issues a command to display the food order including the food items in the food order, the estimated food item preparation time for each of the food items in the food order, the estimated food order preparation time, and the predicted food order ready time on the food preparation display in the food preparation area 104 via an output device interface 210 and a command to display the food order including the food items in the food order and the predicted the food order ready time on the food pick-up display in the food order pick-up area 106 via an output device interface 210 at approximately the same time.

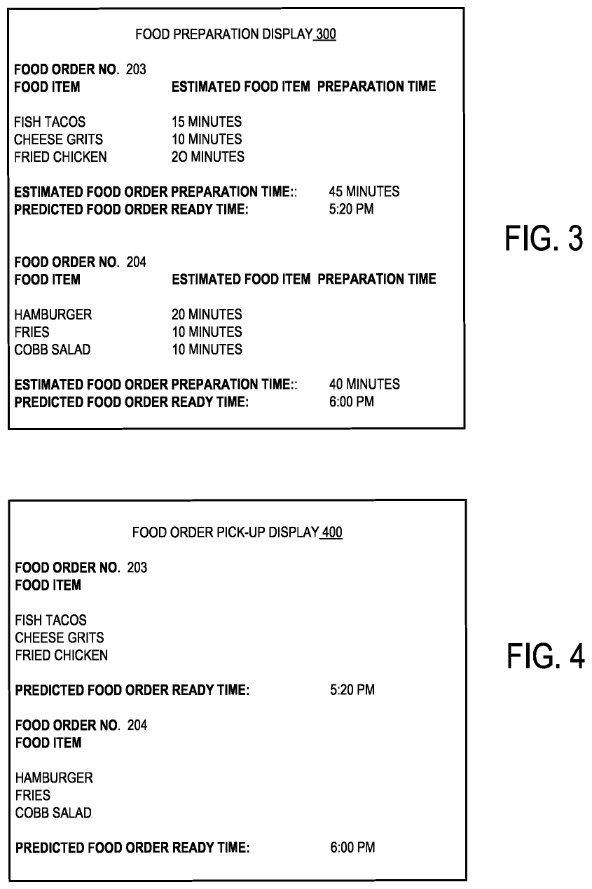

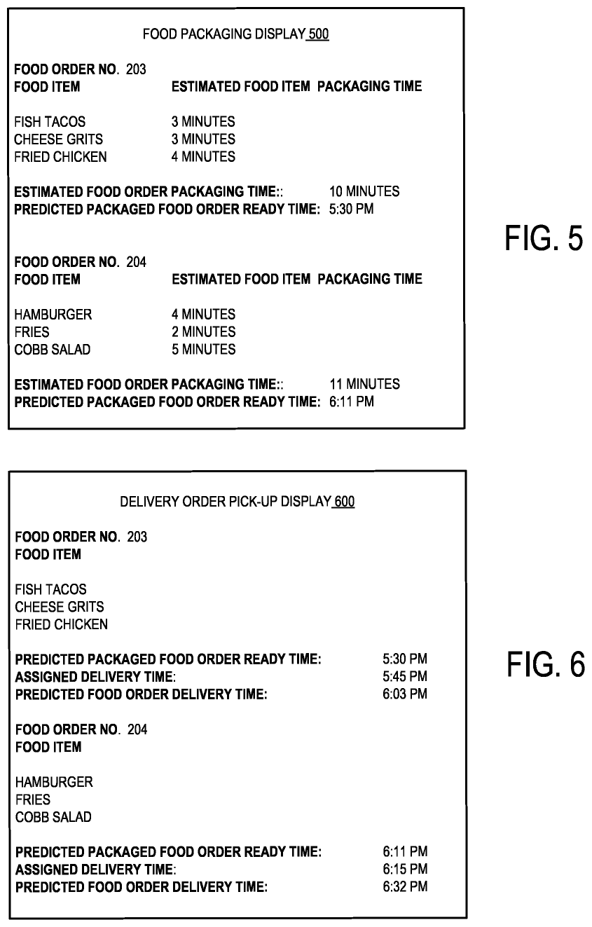

Referring to FIG. 3, an example of a food preparation display 300 displaying the food order including the food items in the food order, the estimated food item preparation time for each of the food items in the food order, the estimated food order preparation time, and the predicted food order ready time is shown. Referring to FIG. 4, an example of a food order pick-up display 400 displaying the food order including the food items in the food order and the predicted the food order ready time is shown. Referring to FIG. 5, an example of a food packaging area display 500 displaying the food order including the food items in the food order, the estimated food item packaging time for each of the food items in the food order, the estimated food order packaging time, and the predicted packaged food order ready time is shown. Referring to FIG. 6, an example of a delivery order pick-up area display 600 displaying the food items, the predicted packaged food order ready time, the assigned delivery time, and the predicted food order delivery time is shown. The food order management system 102 generates the displayed information upon receipt of the food order.

As mentioned above, the food order processor 212 provides the food preparation coordinator 214 with a food order designation that designates the food order as being a food order for dine-in or for delivery. If the food order has been designated for delivery, the food preparation coordinator 214 provides the food order including the food items in the food order, the estimated food item preparation times for each of the food items in the food order, the estimated food order preparation time for the food order, and the predicted food order ready time to the food packaging coordinator 216.

Different food items often have different food item packaging times. The estimated food item packaging time for a food item is an estimate of the amount of time that it takes food packaging personnel in the food packaging area 108 to package the food item. The estimated food item packaging time for each food item on the menu 114 is stored in the food item database 202. In an embodiment, the estimated food item packaging time for a food item is based on an analysis of historical food item packaging times for that food item by the food order management system 102. The food order management system 102 tracks the actual food item packaging time that it takes to package the food item in the food packaging area 106 and updates the estimated food item packaging time for that food item in the food item database 202 in accordance with the tracked actual food item packaging times. In an embodiment, the food management system 102 employs time estimation algorithms to generate the estimated food item packaging times for the different food items and stores the generated estimated food item packaging times in the food item database 202.

The food packaging coordinator 216 accesses the food item database 202 and retrieves the estimated food item packaging time for each of the food items in the food order from the food item database 202. The food packaging coordinator 216 generates an estimated food order packaging time for the food order based on the retrieved estimated food item packaging times for each of the food items in the food order.

The food packaging coordinator 216 identifies the earliest food packaging time available following the predicted food order ready time to package the food items in the food order in the food packaging area 108. The food packaging coordinator 216 tracks the number of pending food orders that are awaiting packaging or are scheduled to be packaged in the food packaging area 108. The food packaging coordinator 216 identifies the earliest available food order packaging time for the food order based on the number of pending food orders and the status of the pending food orders. The food packaging coordinator 216 assigns the identified food order packaging time to the food order. In an embodiment, the food packaging coordinator 216 generates a predicted packaged food order ready time for the food order based on the assigned food packaging time and the estimated food order packaging time. In an embodiment, the food packaging coordinator 216 generates a predicted packaged food order ready time for the food order based on the assigned food packaging time and the estimated food item packaging times for each of the food items in the food order.

In an embodiment, the food order management system 102 coordinates the packaging of the food items in the food packaging area 108 sequentially. In an embodiment, the food order management system 102 coordinates a parallel packaging of one or more food items in the food order in the food packaging area 108. The food packaging coordinator 216 identifies the earliest available food packaging times for each food item in the food order and assigns each of food items to individual food packaging times. The food packaging coordinator 216 generates the predicted packaged food order ready time for the food order based on the food preparation times assigned to individual food items in the food order and the estimated food item preparation time for each food item in the food order.

The food packaging coordinator 216 tracks the actual food item packaging time for the packaging of each of the food items in the food order as well as the food packaging times associated other food orders that are scheduled for packaging in the food packaging area 108. The food packaging coordinator 216 updates the predicted packaged food order ready time based on one or both of the actual food item packaging time for the packaging of each of the food items in the food order and the actual food order packaging times associated other food orders that are scheduled for packaging in the food packaging area 108. The food order management system 102 updates the estimated food item packaging times in the food item database 202 for each of the food items in the food order based on the actual food item packaging times tracked by the food packaging coordinator 216.

In an embodiment, the food order management system 102 is communicatively coupled to cameras and/or other types of sensors located in the food packaging area 108 via the at least one input device interface 206. The cameras and/or other types of sensors provide feedback to the food packaging coordinator 216 regarding the actual food item packaging time of food items in the food packaging area 108.

The food packaging coordinator 216 provides the food delivery coordinator 218 with the food order including the food items in the food order, and the predicted packaged food order ready time for the food order. The food order delivery destination is received at the food delivery coordinator 218 from the food order processor 212. The food delivery coordinator 218 identifies a delivery route from the business establishment 100 to the food order delivery destination. In an embodiment, the food delivery coordinator 218 is communicatively coupled to the Internet via the at least one network interface 208. The food delivery coordinator 218 accesses an application via the Internet that is configured to generate a delivery route based on a food delivery coordinator 218 suppled starting location and a food delivery coordinator 218 supplied destination location. In an embodiment, the food delivery coordinator 218 identifies a delivery route that incorporates the delivery of multiple different food orders to different food order delivery destinations.

The food delivery coordinator 218 identifies the earliest delivery time available following the predicted packaged food order ready time for delivery of the food order to the food order delivery destination. The food delivery coordinator 218 tracks the number of pending food orders that are awaiting delivery or are scheduled to be delivered. The food delivery coordinator 218 identifies the earliest available delivery time for the food order based on the number of pending food orders and the status of the pending food orders. The food delivery coordinator 218 assigns the identified delivery time to the food order. The food delivery coordinator 218 receives delivery route specific data associated with the delivery route and the assigned delivery time for the food order. Examples of delivery route specific data include, but are not limited to, weather conditions and traffic conditions. In an embodiment, the food delivery coordinator 218 accesses one or more of weather and map/direction applications on the Internet via the at least one network interface 208 to retrieve the delivery route specific data.

The food delivery coordinator 218 generates a predicted food order delivery time indicating when the food order is expected to be delivered to the food order delivery destination based on the predicted packaged food order ready time, the delivery route, the assigned delivery time, and the delivery route specific data. The predicted food order delivery time is generated by the food delivery coordinator 218 at the time that the food order is received at the food order management system 102. In some cases, changes may occur in the delivery route specific data as the food order is being prepared and packaged by the business establishment 100. The food delivery coordinator 218 monitors the delivery route specific data for changes and updates the predicted food order delivery time based on any detected changes in the delivery route specific data. The food delivery coordinator 218 receives any adjustments to the predicted packaged food order ready time for the food order from the food packaging coordinator 216 and responsively updates the predicted food order delivery time based on the received adjustments. The food delivery coordinator 218 receives any adjustments to the predicted food order ready time for the food order from the food preparation coordinator 214 and responsively updates the predicted food order delivery time based on the received adjustments. In an embodiment, the food delivery coordinator 218 updates the predicted food order delivery time based on one or both of the actual food item preparation time for each of the food items in the food order and the actual food item packaging times for each food item in the food order.

In an embodiment, the food order management system 102 includes the delivery availability coordinator 220. In an embodiment, business establishment personnel are provided with the option of limiting the number of food orders that are accepted for delivery during a defined time period using the food order management system 102. Business establishment personnel define the time period and enter a maximum percentage of delivery food orders that will be accepted during the defined time period by the food order management system 102. The delivery availability coordinator 220 receives the defined time period and the maximum acceptable percentage of delivery orders for the defined time period. The delivery availability coordinator 220 maintains a running percentage of received food orders that are designated for delivery during the defined time period. When the delivery availability coordinator 220 determines that the percentage of total food orders designated for delivery has met the maximum allowable percentage for the defined time period, the delivery availability coordinator 220 generates an alert indicating that the maximum percentage of allowable food orders designated for delivery during the defined time period has been reached. In an embodiment, the delivery availability coordinator 220 disables the entry of additional food orders for delivery into the food order management system 102 once the maximum percentage of allowable food orders for delivery during the defined time period has been met.

In an embodiment, the delivery availability coordinator 220 reviews historical food order data designations to generate an estimated number of dine-in food orders typically received during a pre-defined business establishment operation time. The delivery availability coordinator 220 reviews the historical food order data to estimate the food preparation resources used to prepare food orders for dine-in customers during the pre-defined business establishment operation time and estimates food preparation resources available to handle food orders that are designated for delivery. The delivery availability coordinator 220 sets a maximum acceptable percentage of delivery orders for the pre-defined business establishment operation time based on the estimated food preparation resources available to handle food orders that are designated for delivery. The delivery availability coordinator 220 maintains a running percentage of received food orders that are designated for delivery during the pre-defined business establishment operation time. When the delivery availability coordinator 220 determines that the percentage of total food orders designated for delivery has met the maximum allowable percentage for the pre-defined business establishment operation time, the delivery availability coordinator 220 generates an alert indicating that the maximum percentage of allowable food orders designated for delivery during the pre-defined business establishment operation time has been reached. In an embodiment, the delivery availability coordinator 220 disables the entry of additional food orders for delivery into the food order management system 102 once the maximum percentage of allowable food orders for delivery during the pre-defined business establishment operation time period has been met.

In an embodiment, the delivery availability coordinator 220 adjust the maximum acceptable percentage of delivery orders for the pre-defined business establishment operation time based on one or more delivery related parameters that may impact the ratio of dine-in customers to food order delivery customers. Examples of such delivery related parameters include, but are not limited to weather conditions, traffic conditions, seasonal conditions (such as for example, expected tourism), the presence, opening, and/or closing of nearby restaurants. For example, inclement weather conditions may result in fewer dine-in customers but a greater number of delivery orders. In an embodiment, the delivery availability coordinator 220 includes a web crawler that identifies the recent status of the delivery related parameters and provides the recent status of the delivery related parameters to the delivery availability coordinator 220. The delivery availability coordinator 220 adjust the maximum acceptable percentage of delivery orders for the pre-defined business establishment operation time based on one or more received parameters.

In an embodiment, the food order management system 102 includes an advance food preparation coordinator 222. The advance food preparation coordinator 222 identifies food items on the menu 114, that can be prepared in advance. In an embodiment, the advance food preparation coordinator 222 reviews historical food preparation time data for the food preparation area 104 to identify business establishment operation time periods with relatively low usage of food preparation resources. The advance food preparation coordinator 222 assigns the preparation of one or more food items on the menu 114 that can be prepared in advance to the identified business establishment operation time periods with relatively low usage of food preparation resources.

In an embodiment, the advance food preparation coordinator 222 determines a batch size for the food items that are prepared in advance. The ingredient list for each of the food items on the menu 114 are stored in the food item database 222. The ingredient list includes the specific ingredients and the amount of each of the ingredients used to prepare the food item. The advance food preparation coordinator 222 retrieves the ingredient list for a food item that has been selected for advance preparation from the food item database 202. The advance food preparation coordinator 222 reviews an inventory of the ingredients used to prepare the food item available for use in the food preparation area 104. The advance food preparation coordinator 222 determines the batch size for the food item that has been selected for advance preparation based on the inventory of ingredients available to prepare the food item.

In an embodiment, advance food preparation coordinator 222 identifies the food items that can be prepared in advance and prioritizes the preparation of the food items that can be prepared in advance based on the order frequency of the food items. The advance food preparation coordinator 222 prioritizes the preparation of the food items that can be prepared in advance based on an analysis of historical food item order frequency data.

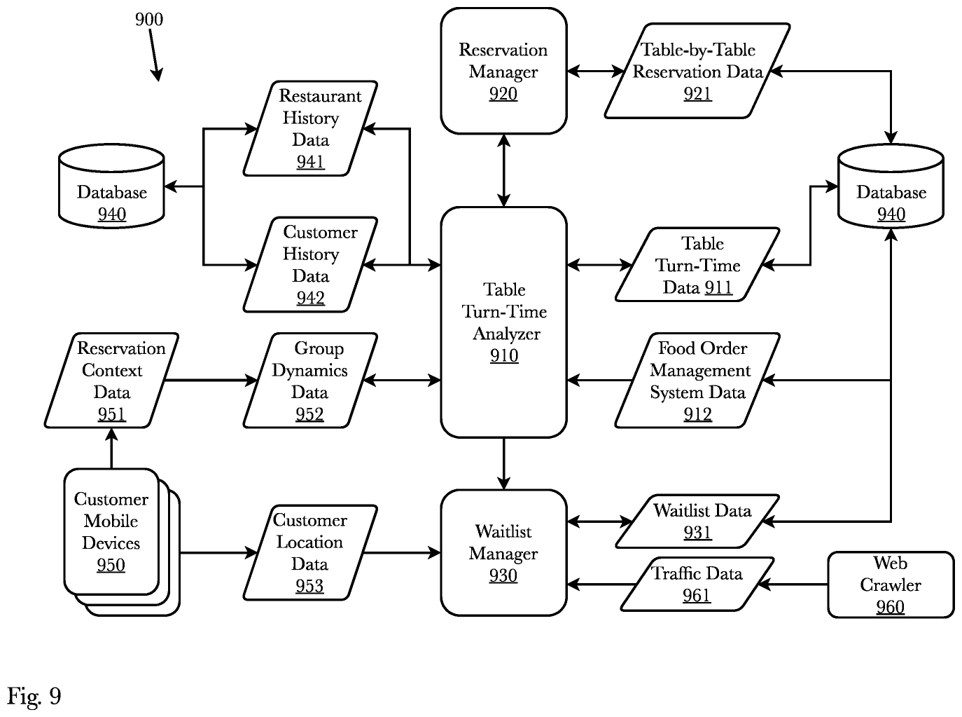

FIG. 9 is a block diagram showing an exemplary system architecture of a system 900 for dynamic reservation and waitlist management using precision table turn-time analysis. Although other configurations are possible and not all components may be required, the system in this embodiment comprises a table turn-time analyzer 910, a reservation manager 920, a waitlist manager 930, one or more databases 940, and a web crawler 960. The table turn-time analyzer 910 retrieves relevant data such as food order management system data 912, restaurant history data 941 and customer history data 942 from a database 940, and makes predictions for table-by-table turn times based on current and historical data. The restaurant history data 941 comprises data regarding historical table turn-times, and may include data that supplement or augment the historical table turn-times such as differences in turn-times based on a variety of factors such as time of day, day of the week, type(s) of food ordered at a given table, food preparation times, the restaurant staff on duty and their experience levels, customer mix, special event information, and other information that may explain or add precision to the historical table turn-times. The customer history data 942 comprises data about repeat customers of the restaurant. The customer history data 942 may be acquired in a number of ways. For example, it may be entered manually by restaurant staff who know the customer well (e.g., for “regulars” whose habits the restaurant staff know well), or may be entered when a reservation or seating is made after querying the customer, or may be captured from a customer mobile device 950 running an application designed to interact with the system. Customer mobile devices 950 running an application programmed to connect to, and interact with, the system may supply the system with additional relevant data such as reservation context data 951, group dynamics data 952, and customer location data 953. Reservation context data 951 comprises information that suggests a context in which the reservation is being made such as for a particular purpose like a business meeting or a romantic date, for a special event like a wedding or celebration of a sports event win. The context of a reservation may provide important information regarding the length of time that the customer or customers will remain at the restaurant, and therefore may affect table turn-time calculations. Reservation context data 951 may be obtained by querying the customer at the time the reservation is made, either in person, on the phone, or through submission of a reservation form online, or by inference from other data such as customer history data (e.g., if customer history data of two customers indicates that they often have business meetings together on Mondays). Reservation context data may further give rise to group dynamics data 952. Group dynamics data 952 comprises information related to two or more customers which may further impact the length of stay at the restaurant. For example, a group of single sports fans at a sports bar may stay to watch the entire length of a game, whereas a group of sports fans with kids may not be able to stay for the entire game. Customer location data 953 comprises information about the customer's location relative to the restaurant, and may be used by the waitlist manager to prioritize or re-organize waitlist slots. Customer location data 953 may be obtained visually (e.g., by restaurant staff) or electronically, for example, by sending a text query to a customer mobile device 950 or by having the customer mobile device 950 send location information to the system (for example, satellite-based global positioning data).

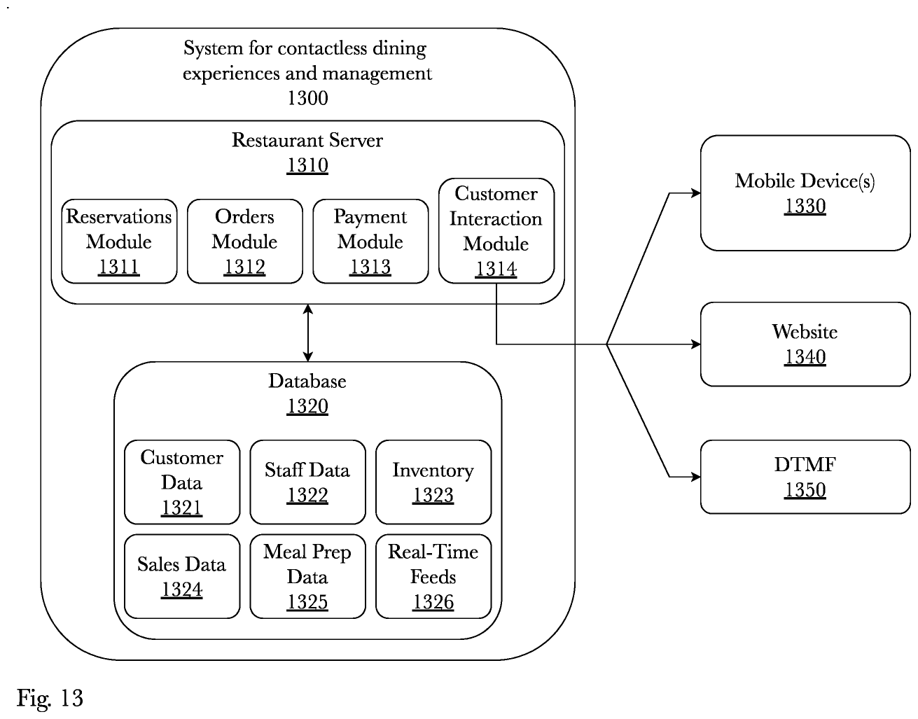

FIG. 13 is a block diagram representation of an end-to-end contactless dining experience and management system 1300. According to one embodiment, the system comprises a restaurant server 1310 and a database 1320. The restaurant server 1310 further comprises a reservations module 1311, an orders module 1312, a payment module 1313, and a customer interaction module 1314. The reservations module 1311, uses predictive scheduling algorithms 1100 and customer input (via the customer interaction module 1314) to efficiently manage and optimize reservations for a business. The orders module 1312, presents menus to customers, takes orders from customers, and coordinates with the reservations module 1311 in order to derive an optimum time for customers to arrive at a restaurant and to be seated such that the food order is brought out when the order is at its best. The information contained in the database 1320 is used in part for predictive algorithms, as an example: customer data 1321 may inform algorithms that a particular customer is on average five minutes late or that a customer typically orders additional food when they arrive; staff data 1322 may inform predictive algorithms if some kitchen staff are slower than others or an error rate of certain wait staff; inventory 1323 informs algorithms if some food items may not be available or to offer discounts on meals prepared with certain ingredients that are about to expire; sales data 1324 informs the algorithms about current seating capacity, transactions to date (which may further inform dynamic pricing), etc.; meal prep data 1325 informs predictive algorithms how long it will take to complete an order; and real time feeds 1326 may inform predictive algorithms about weather patterns, traffic congestion, and other dynamic events which may affect scheduling and wait lists. These are only some usage examples of the data 1321-1326 within the database 1320 and is not all-encompassing or meant to be limiting in any way.

The payment module 1313 also coordinates with the reservations module 1311 and the orders module 1312 so that bill splitting, and other functions of payment maybe garnered. One example is that the reservations module informs the payment module which customers are seated at which tables. Some embodiments allow the payment module to directly communicate with the database 1320. The customer interaction module 1314 facilitates the customers interaction with the restaurant server 1310 via mobile devices 1330 such as smartphones, tablets, and e-readers, a website 1340, and via automated telephone calls (DTMF 1350).

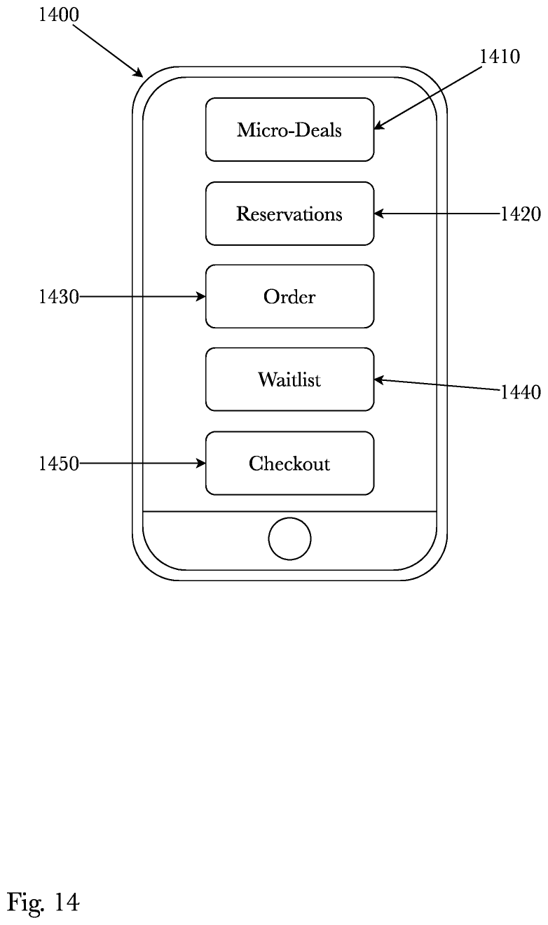

FIG. 14 is a block diagram representation of a customer using a mobile device with an end-to-end contactless dining experience application. According to one embodiment, an application on a smart device 1400 that is communicatively coupled to the server may present a user with a variety of options. Five options 1410-1450 are disclosed in FIG. 14 but other options such as settings, payment options, cart, sign-in, previous orders, sharing, profile settings, social media integration, and other well-known mobile application features are to be inferred.

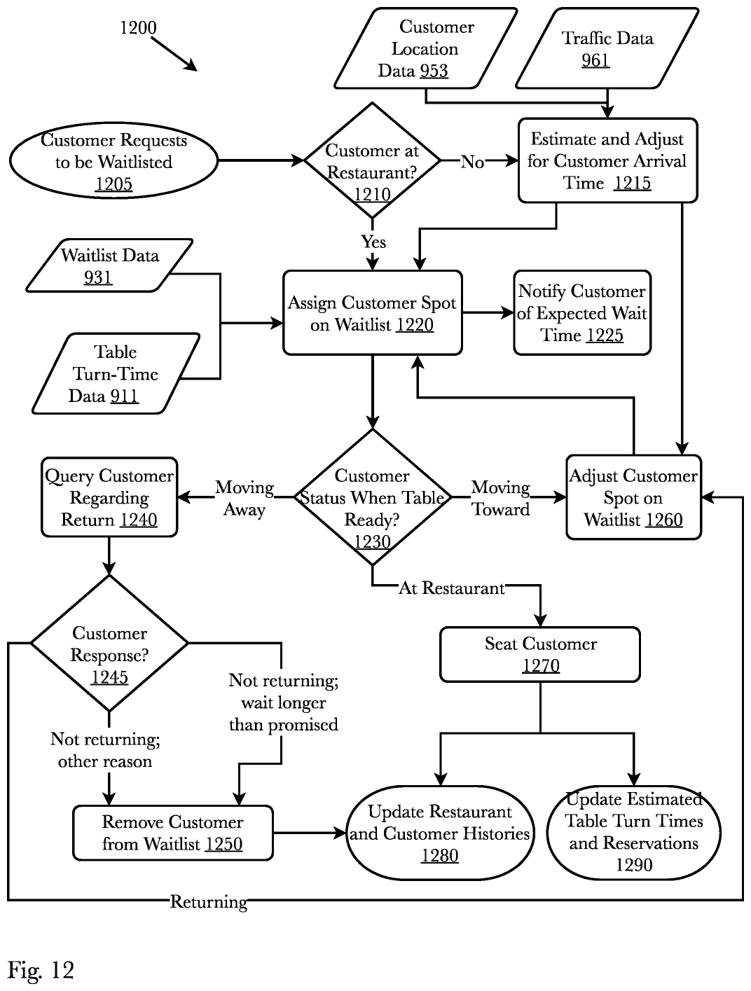

Micro-deals is one option that may be presented to a user using push notifications or simply by tapping the micro deals button 1410. Micro deals comprise discounts and incentives for customers to order and may be decided using predictive algorithms of inventory and stock or in times of slow business. Reservations 1420 is an option presented to a user such that they may make new reservations or change or cancel existing reservations. The order option 1430 allows a customer to place an order for food items. According to one embodiment, upon a customer clicking the order button 1430, a second menu will be displayed wherein the user may choose dine-in and be subsequently brought to the reservations menu 1420. In one embodiment, a waitlist option 1440 may be presented such that the user is presented with a series of options as disclosed in FIG. 12. The checkout option 1450 may not be visible in must an active order has already been placed in which case, the checkout option 1450 allows the customer to settle their bill or perform bill splitting with other party members.

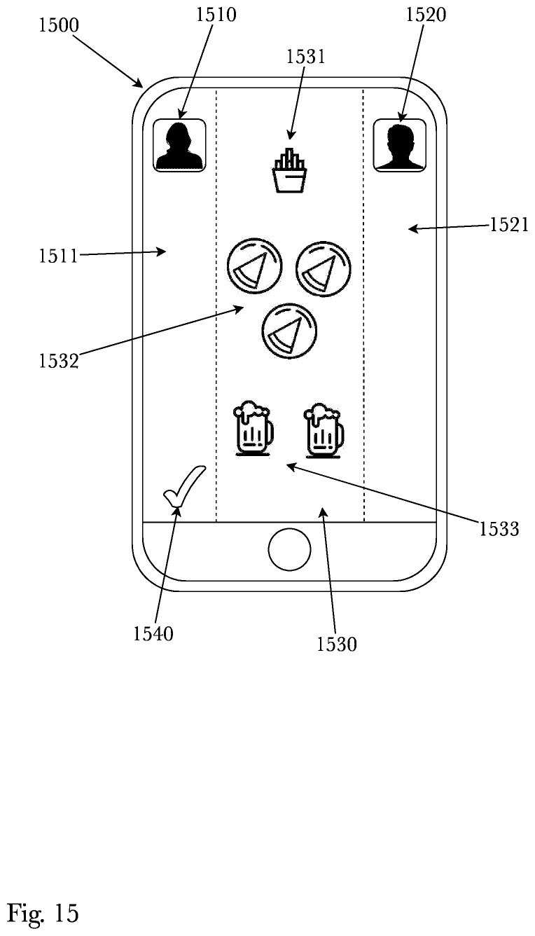

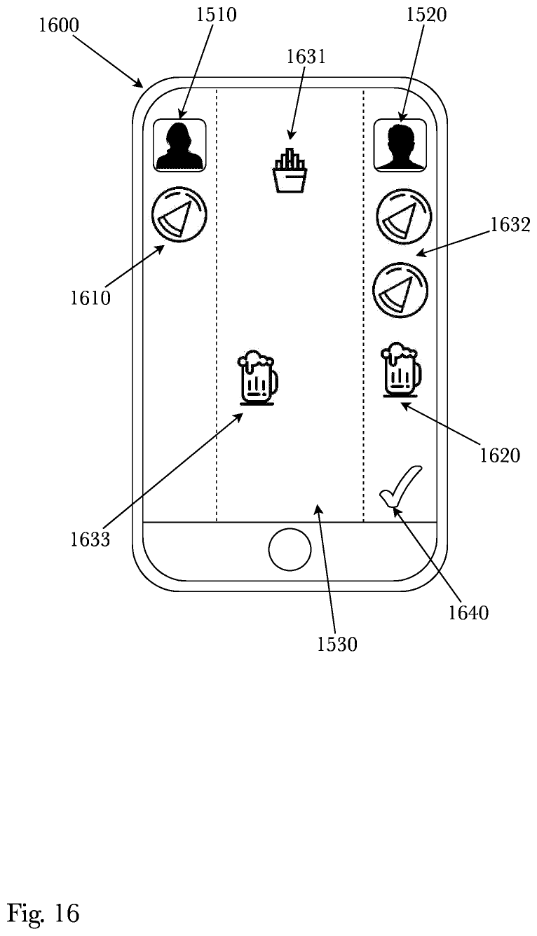

Referring to FIG. 15 and FIG. 16, a party of two finishes a meal and both party members are using their own respective mobile devices 1500, 1600 for bill splitting. A first customer using a first mobile device 1500, and designated by a profile picture 1510 on both devices 1500, 1600, sees a center portion 1530 of the mobile application wherein the food items ordered by the party are displayed 1531, 1532, and 1533. Food items may be selected by either member by dragging the food icon to his or her respective side, thus claiming responsibility of payment for that particular food item. The movement of food items 1531, 1532, and 1533 is displayed in real time. FIG. 15 shows an initial time when no party member has selected any food item, while FIG. 16 shows that the first customer 1510 has dragged one slice of pizza 1610 to her side 1511, while a second customer, represented by a second profile picture 1520, has selected two slices of pizza 1632 and one pitcher of beer 1620 and dragged those items to his side 1521. The leftover items 1631, 1633 will be split amongst both party members unless they talk across the table and decide differently. Once both parties have finished, they may select the finish icon 1540, 1640 in which a payment from both will be collected. The payment screen that follows the bill splitting may include options for tax and tips.

FIG. 15 and FIG. 16 are merely exemplary and are not meant to convey any limitation to the order of bill splitting and payment, the layout of the bill splitting screen, or any other design features of bill splitting and the payment module. Any number of layouts and graphical elements representing food items and patron profiles may be imagined by those with ordinary skill in the art. Bill splitting and payments may also occur on a website or by DTMF options over a telephone line (for example, an automated voice may ask a customer to choose 1 to accept item or 2 to leave the item in the center queue).

### Detailed Description of Exemplary Aspects

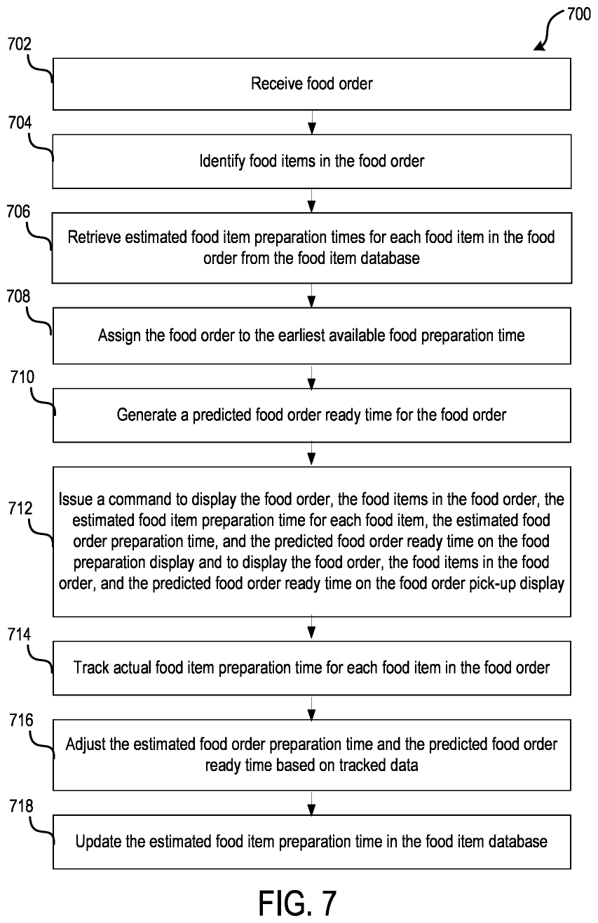

Referring to FIG. 7, a flow diagram representation of an example of a method 700 of managing preparation of food items in a food order using an embodiment of a food order management system 102 is shown. At 702, a food order including one or more food items is received at the food order management system 102. The food order management system 102 identifies the food items in the food order at 704 and retrieves the estimated food item preparation time for each of the food items in the food order from the food item database 202. The estimated food item preparation time for a food item is an estimate of the amount of time that it takes food preparation personnel in the food preparation area 104 to prepare the food item.

The food order management system 102 generates an estimated food order preparation time based on the retrieved estimated food item preparation times for the food items in the food order at 706. The food order management system 102 assigns the food order to the earliest available food preparation time in the food preparation area 104 at 708 and generates a predicted food order ready time for the food order at 710. The predicted food order ready time is based on the assigned food preparation time and the estimated food order preparation time. The predicted food order ready time is the time when the completed food order is expected to be placed in the food order pick-up area 106.

The food order management system 102 issues a command to display the food order including the food items in the food order, the estimated food item preparation time for each of the food items in the food order, the estimated food order preparation time, and the predicted food order ready time on a food preparation display and to display the food order including the food items in the food order and the predicted food order ready time on a food order pick-up display at 712.

The food order management system 102 tracks the actual food item preparation times for each of the food items in the food order in the food preparation area 104 as each food item is being prepared at 714. The food order management system 102 adjusts the estimated food order preparation time and the predicted food order ready time for the food order to reflect any differences between the estimated food item preparation times and the actual food item preparation times for the food items in the food order at 716. The food order management system 102 updates the estimated food item preparation times for each of the food items in the food order in the food item database 204 based on the actual food item preparation times for the food items at 718.

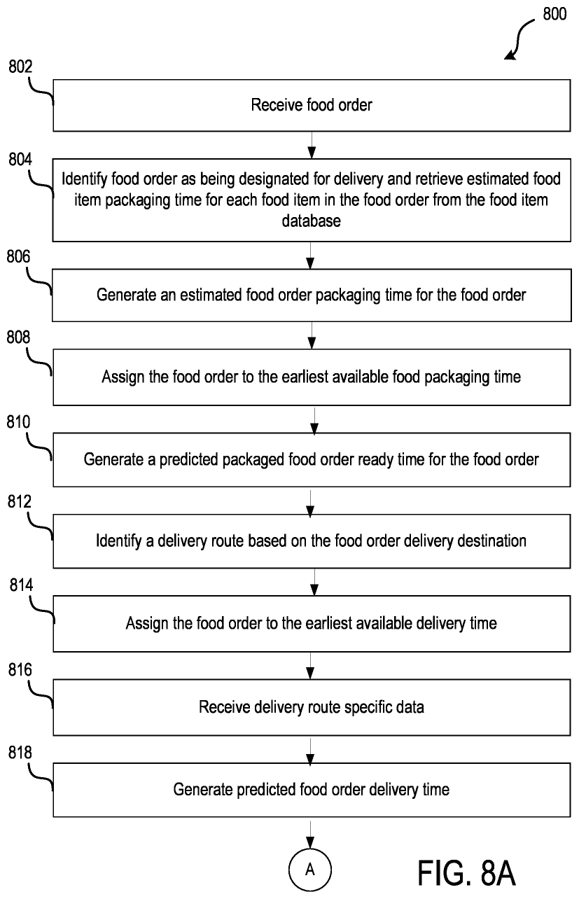

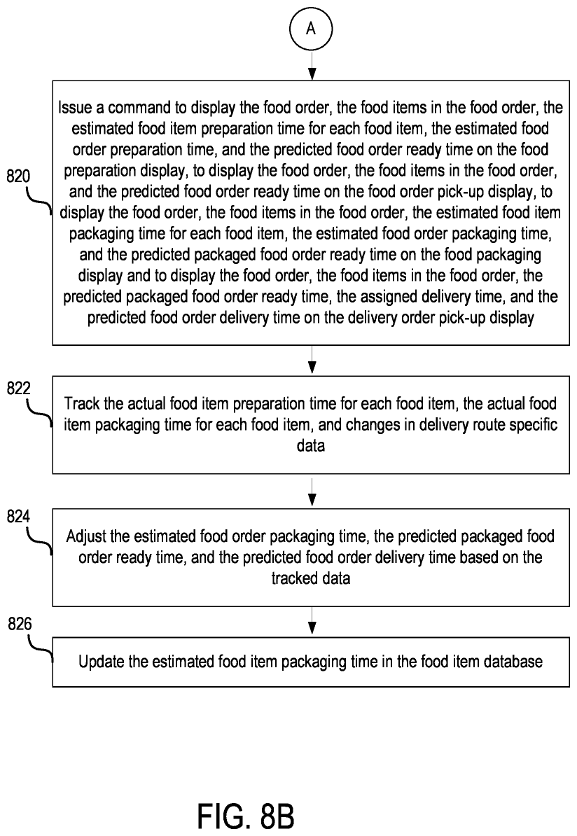

FIG. 8A is a flow diagram representation of an example of a method 800 of managing delivery of a food order illustrating the flow from receipt to generation of an estimated delivery time. At 802, a food order including one or more food items is received at the food order management system 102. The food order management system 102 identifies the food order as being designated for delivery and retrieves the estimated food item packaging time for each of the food items in the food order from the food item database 202 at 804. The estimated food item packaging time for a food item is an estimate of the amount of time that it takes food packaging personnel in the food packaging area 108 to package the food item.

The food order management system 102 generates an estimated food order packaging time based on the retrieved estimated food item packaging times for the food items in the food order at 806. The food order management system 102 assigns the food order to the earliest available food packaging time in the food packaging area 108 at 808 and generates a predicted packaged food order ready time for the food order at 810. The predicted packaged food order ready time is based on the assigned food packaging time and the estimated food order packaging time. The predicted packaged food order ready time is the time when the packaged food order is expected to be placed in the delivery order area 110.

The food order management system 102 identifies a delivery route for the food order based on the food order delivery destination at 812 and assigns an earliest available delivery time for the delivery of the food order to the food order delivery destination at 814. The food order management system 102 receives delivery route specific data based on the identified delivery route and the received delivery route specific data at 816 and generates a predicted food order delivery time at 818. The predicted food order delivery time is the time that the food order is expected to be delivered to the food order delivery destination and is based on the predicted packaged food order ready time, the delivery route, the assigned delivery time, and the expected delivery route specific data.

FIG. 8B is a flow diagram representation of an example of a method of managing delivery of a food order illustrating the flow from displaying a food order through updating an estimated food packaging time with a food item database. The food order management system 102 issues a command to display the food order including the food items in the food order, the estimated food item preparation time for each of the food items in the food order, the estimated food order preparation time, and the predicted food order ready time on a food preparation display, to display the food order including the food items in the food order and the predicted food order ready time on a food order pick-up display, to display the food order including the food items in the food order, the estimated food item packaging time for each of the food items in the food order, the estimated food order packaging time, and the predicted packaged food order ready time on a food packaging display, and to display the food order including the food items, the predicted packaged food order ready time, the assigned delivery time, and the predicted food order delivery time on a delivery order display at 820.

The food order management system 102 tracks the actual food preparation times for each of the food items in the food order in the food preparation area 104 as each food item is prepared, the actual food packaging times for each of the food items in the food order in the food packaging area 108 as each food item is packaged and any changes in the delivery route specific data at 822. The food order management system 102 adjusts the estimated food order packaging time, the predicted packaged food order ready time, and the predicted food order delivery time for the food order to reflect any changes in the delivery route specific data, differences between the estimated food item preparation times and the actual food item preparation times and/or differences between the estimated food item packaging times and the actual food item packaging times associated with the packaging of the food items at 824. The food order preparation system 102 updates the estimated food item packaging times for each of the food items in food item database 204 based on the actual food item packaging time for the food item at 826.

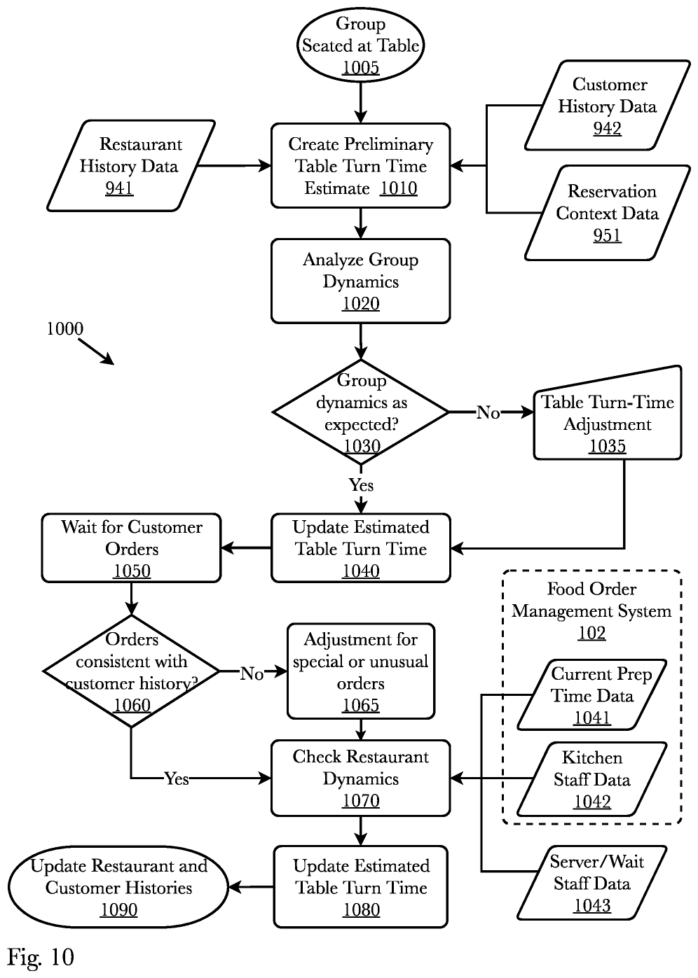

FIG. 10 is a flow diagram showing an exemplary algorithm for implementation of a dynamic table turn-time analyzer 1000. In this exemplary algorithm, the process is initiated when a group is seated at a table 1005. Restaurant history data 941, customer history data 942, and reservation context data 951 are retrieved and analyzed, and a preliminary table turn-time estimate for that table is created 1010. For example, if the restaurant history indicates that groups of five persons dining at a particular time of the week are typically business professionals having a quick lunch, it may be expected that the table turn-time for a group of five seated during that time will take 40 minutes. The reservation context data indicates that the group is at the restaurant for a birthday celebration, which would suggest an additional 30 minutes. However, there is customer history for three of the customers that indicates that those three customers rarely stay beyond an hour, suggesting a reduction in table-turn time of 5 minutes, for a preliminary table turn-time estimate of 65 minutes.

The preliminary table turn-time estimate will suggest a particular group dynamic, but it is possible that actual group dynamics are different than expected. Group dynamics may be analyzed 1020 to determine whether they are as expected or predicted given the data retrieved at the previous step. Group dynamics may be obtained, for example, by comparing customer profiles obtained from each customer's mobile device 950 or stored in each customer's customer history data 962, or from manual inputs by restaurant staff. As one example, a comparison of the customer profiles for all of the customers at the table may indicate that, while they are there for a business meeting, they all have a strong interest in golf, which may lead them to stay at the table to discuss golf after the business meeting is concluded, leading to an automated table turn-time adjustment 1035. As another example, the table's server may notice that all of the members of the group are wearing shirts with logos of the local sports team, and that they've noticed that their team is playing a game being shown on the bar's television which may cause them to stay longer than expected. If the group dynamics are not as expected or predicted at an earlier stage 1030, the table's server may make a manual table turn-time adjustment 1035 to indicate the change in expected group dynamics, and the table turn-time may be updated, accordingly 1040.

Once the customers have ordered 1050, their orders may be checked 1060 against the customer history data 962 that was used to create the preliminary table turn-time estimate 1010. If the orders do not correspond to the customer history data 962, an adjustment may be made for special or unusual orders 1065. At this point, restaurant dynamics are checked 1070 to determine any known or predicted factors that may affect the table turn-time. Inputs may include data such as current prep time data 1041 and kitchen staff data 1042 from the food order management system 102, and server or wait staff data 1043 indicating the experience and efficiency of the staff. Final updates are made to the estimated table turn-time 1080, and restaurant and customer histories are updated in response 1090.

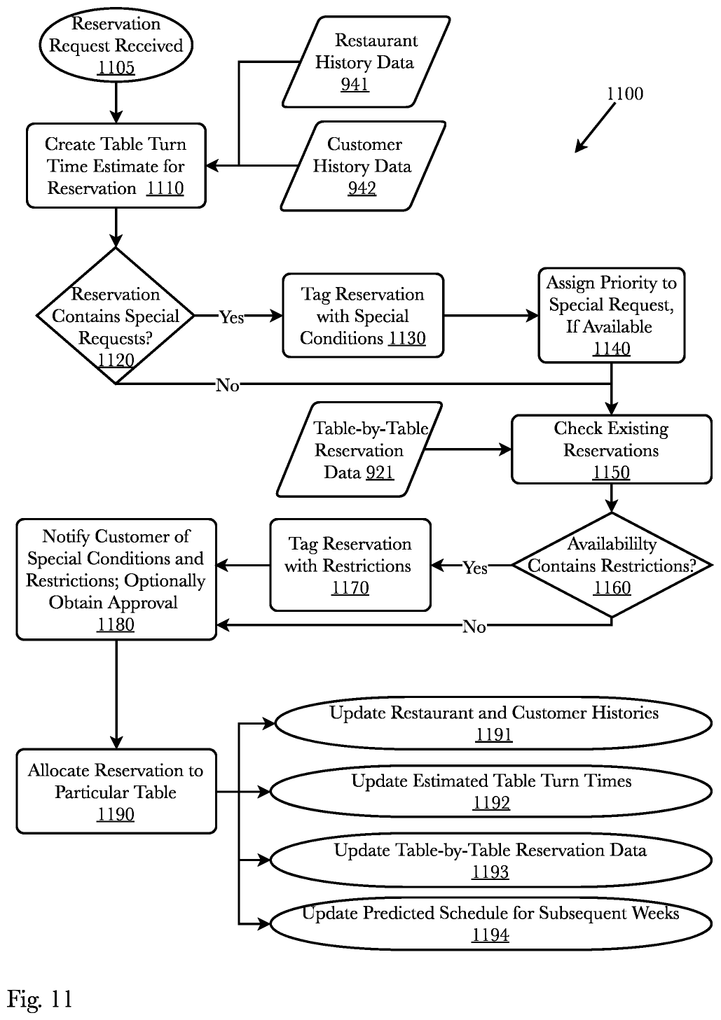

FIG. 11 is a flow diagram showing an exemplary algorithm for implementation of a dynamic reservation manager 1100. In this exemplary algorithm, the process is initiated by the receipt of a reservation request 1105 from a customer. The reservation request 1105 may be received directly by the system, as in the case of online reservations by the customer, or may be entered by restaurant staff after having communicated with the customer (e.g., by phone, in person, etc.). Restaurant history data 941 and customer history data 942 are retrieved, and using these data, a table turn time estimate is created for the reservation 1110. For example, a solo dining reservation may be made by a customer whose customer history data 942 indicates that the customer tends to linger at the table after eating, which would lead to an estimate of a one hour table turn-time. The reservation is made for 6 pm on a Saturday, a time that is particularly busy for the restaurant, adding 30 minutes to the estimate. However, the restaurant history also indicates that the restaurant staff on duty on Saturdays is particularly experienced, leading to a 10 minute reduction in the estimate. Thus, in this example, the table turn-time estimate for the reservation 1110 would be 80 minutes.

The reservation is then analyzed to determine whether the reservation contains any special requests 1120, such as a request for seating at a table in front of the window or other special services the restaurant may offer, such as candle-lit dinners. If the reservation contains special requests, the reservation is tagged with any applicable special conditions 1130, such as a minimum order for that reservation or premium pricing like a surcharge for tables next to a window. The special request is then assigned priority 1140 such that the reservation is given priority over reservations that do not have a special request, and table assignments may be adjusted, accordingly. Table-by-table reservations data 921 are then retrieved, and the existing reservations shown in the data are checked to determine table availability for the requested reservation 1150. If reservations are available, but there are restrictions on the availability 1160, the reservation is tagged with restrictions 1170. As an example of a restriction on availability, a table may be available, but only for a time that is shorter than the standard table turn-time for that restaurant. The customer is then notified of any special conditions and restrictions associated with the requested reservation, if any, and the customer's approval of the special conditions and restrictions may optionally be required 1180. For example, it may be the case that a reservation contains a special request for a table by the window. A surcharge is applicable for reservation of window tables. A window table is available, but only for a 45 minute period. The customer is notified of the surcharge and availability restriction and the customer's approval of the availability restriction may be required. The notification may be by any means reasonably available in the situation, for example in person, by phone, by text message, or automatically through a website or an application running on the customer's mobile device 950. At this point, the requested reservation is allocated to a particular table for a particular time period 1190, and a number of updates are made to data, including updating the restaurant and customer histories 1191, updating the estimated table turn-times 1192, updating the table-by-table reservation data 1193, and updating the predicted schedule for subsequent time periods 1194, for example, subsequent days, weeks, or months.

FIG. 12 is a flow diagram showing an exemplary algorithm for implementation of a dynamic waitlist manager 1200. In this exemplary algorithm, the process is initiated by a request from a customer to be placed on the waitlist (alternatively, wait list) for a table 1205. This request may be placed by the customer while at the restaurant or remotely (e.g., by telephone, or through an application running on the customer's mobile device 950, while the customer is en route to the restaurant. A determination is made as to whether the customer is at the restaurant when the reservation is made 1210. If the customer is at not the restaurant, the customer's location data 953 and traffic data 961 are gathered, and the customer's arrival time at the restaurant is estimated 1215. If the customer is at the restaurant or the customer's arrival time has been estimated 1215, waitlist data 931 and table turn-time data 911 are retrieved and based on an analysis of the data, the customer is assigned a spot (or slot) on the waitlist 1220 and notified of the expected wait time 1225. A customer on the waitlist may either have placed the request from a remote location, or may wander about or change locations while waiting for a table. For example, if the restaurant is located at a mall or other shopping location, a customer on the waitlist may spend his or her expected wait time shopping. When the customer's table is ready, the customer's status is determined 1230. If the customer is at the restaurant, he or she will be seated 1270, removed from the waitlist, and updates will occur to restaurant and customer history data 1280 and estimated table turn-times and reservation data 1290. A customer who is not at the restaurant when the table is ready, but who is moving toward the restaurant will be assumed to be returning to the restaurant. That customer's location data 953 and traffic data 961 may again be retrieved to adjust his or her estimated arrival time 1215, and may be re-assigned a later spot on the waitlist 1220. A customer who is not at the restaurant when the table is ready and who is moving away from the restaurant will be assumed to be leaving and not returning to the restaurant, and a query is made of the customer's intent 1240. The query may be made by any means reasonably available, such as a phone call, a text message, or through an application running on the customer's mobile device 950. If the customer responds 1245 and indicates that he or she is not returning or does not respond, the customer will be removed from the waitlist 1250, and the restaurant and customer history data will be updated 1280. The updates may include a reason for the customer's removal, and where the removal was justified (e.g., wait time longer than expected), the customer's history data may be adjusted to prioritize the customer in the waitlist on subsequent visits. Where the removal was not justified, the customer's history data may be adjusted to de-prioritize the customer in the waitlist on subsequent visits. If the customer indicates that he or she is returning, the customer's spot on the waitlist is adjusted 1260, and re-assigned 1220.

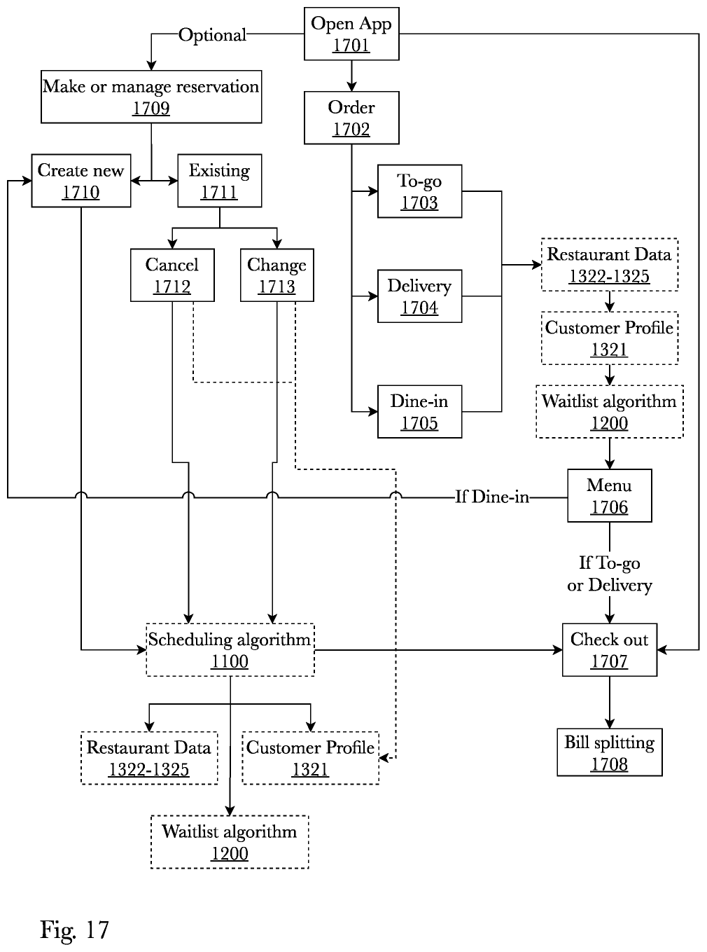

FIG. 17 is a flow diagram showing an exemplary algorithm for implementation of an end-to-end contactless dining experience and management system driven smartphone application. According to various embodiments, these exemplary steps contained herein may apply to a mobile application installed or streaming on a mobile device, a website or other web service, and a DTMF prompt service over a telephone line. In the case of the mobile application, the customer will initialize or open the said application 1701 from which there will be a series of graphical user elements offering to place an order 1702. Other options may present themselves based on the desired implementation, if there are existing orders, or based on user preferences. Should the customer choose order 1702, subsequent choices (To-go 1703, Delivery 1704, and Dine-in 1705) are presented asking the customer how they will be experiencing the service. To-go 1703 and delivery 1704 brings the customer to a menu 1706 where the customer may choose food options. Food options presented may be dynamically altered based on food availability and other metrics via restaurant data 1322-1325. Food options may also be prioritized or discounted based on customer preferences 1321. Food choices may also be presented in a specific order due to timing considerations. For example, the reservations module using the scheduling algorithm 1100 and other predictive algorithms may inform the orders module on food that takes less time to order should the restaurant be extremely busy. The customer may not choose the quicker items, but food items may be presented in such an order to incentivize ordering of those quicker items. Once the To-go 1703 or delivery 1704 food items have been ordered, the reservations module using at least the scheduling algorithm 1100, will predict the time the order will be ready for pickup or delivery. The reservations module taking into consideration kitchen staff performance and efficiency, meal prep times, real-time feeds about weather and traffic, among other consideration disclosed herein. Lastly To-go 1703 and delivery 1704 customers will be taken to the checkout menu 1707. If multiple customers on separate devices both ordering to the same location, using the generated alphanumeric number or QR code described earlier, then bill splitting 1708 may be presented as an option.

Consider the initial state again 1701, where a customer is located somewhere other than the restaurant and now chooses order 1702 and subsequently dine-in 1705. The customer will then be brought to the menu option 1706 as before, however, now the waitlist algorithm 1200 will also work in parallel with the scheduling algorithm 1200 (via the reservations module) such that after the dine-in customer completes the food order, create new 1710 reservation will be presented to the customer, and the optimal time of arrival will be calculated at least based on waitlists, schedules, meal prep time, and customer travel time. If a reservation is successful and the customer wishes to change 1713 or cancel 1712 the existing 1711 reservation, an option to do so 1709 will be presented on the home screen of the application, according to one embodiment. Optionally, the make or manage reservation option 1709 may be displayed from the initial state of the application even when no existing reservation is made. To this end, the customer may make reservations without making predetermined food choices.

This diagram is merely exemplary. The order in which options are presented maybe altered and swapped to fit different applications or restaurant models. For example, the checkout option may be hidden from view unless an active reservation is found and subsequently presented on the home screen of the app or found under the make or manage reservation option, or both. Another example may consist of having the make or manage reservation option on the home screen or place it under the order food option, or both. Therefore, it should be understood that the order of the steps may be done in any fashion as seen fit during implementation and the graphical layout and design of such as application may take many shapes and forms with the same overall intent for predictive algorithms and end-to-end contactless dining experience and management as disclosed herein.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

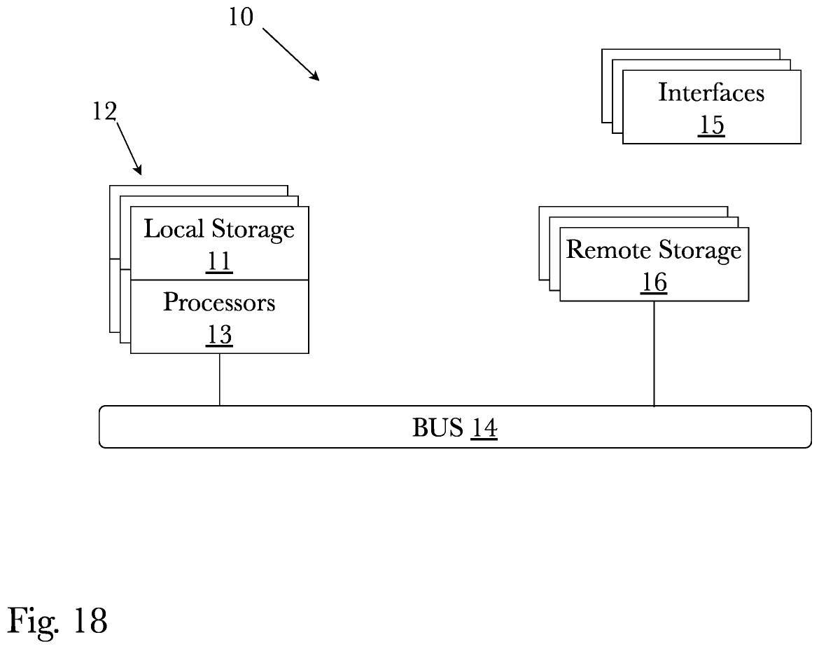

Referring now to FIG. 18, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 18 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

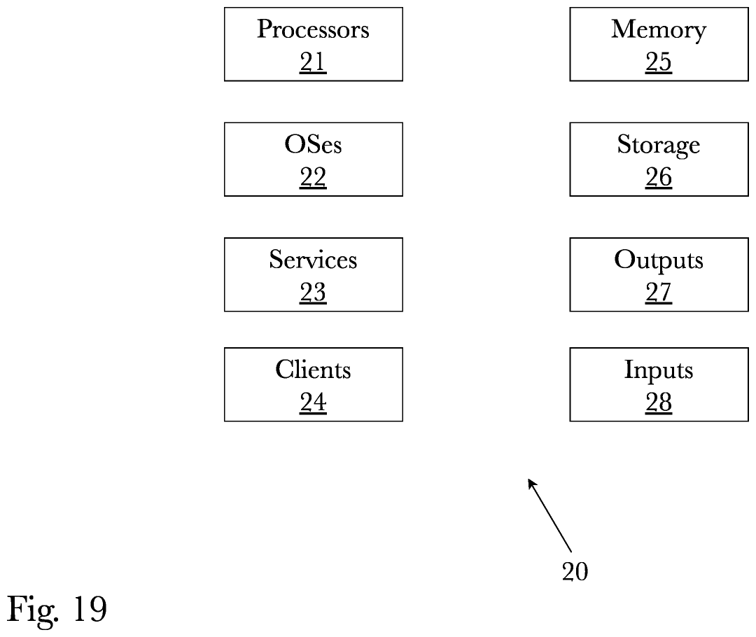

In some aspects, systems may be implemented on a standalone computing system. Referring now to FIG. 19, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 18). Examples of storage devices 26 include flash memory, magnetic hard drive, CD-ROM, and/or the like.

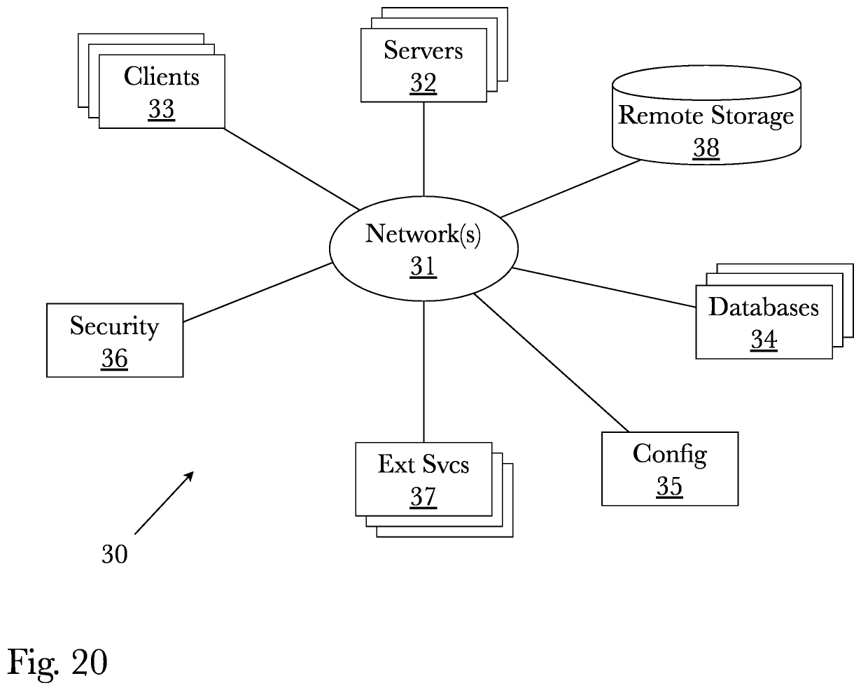

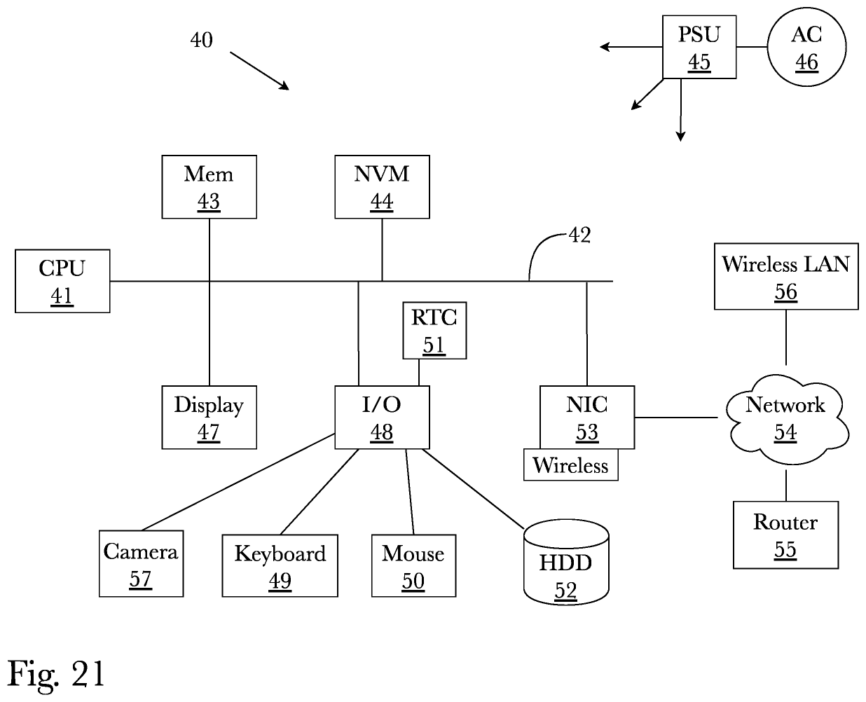

In some aspects, systems may be implemented on a distributed computing network, such as one having any number of clients and/or servers. Referring now to FIG. 20, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 19. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

FIG. 21 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for end-to-end contactless dining experience and management, comprising:
a database, wherein the database comprises a customer profile and meal preparation times; and
a restaurant server comprising a first plurality of programming instructions stored on a memory of, and operating on a processor of, a computing device, wherein the first plurality of programming instructions, when operating on the processor, causes the processor to:
receive a customer's request for a reservation;
receive an order associated with the reservation;
calculate an earliest arrival time for the customer, wherein the earliest arrival time is based on a scheduling algorithm, a waitlist algorithm, the profile of the customer, and the meal preparation time of the order;
send the earliest arrival time to the customer;
receive an acknowledgement confirming the earliest arrival time;
send customized instructions to restaurant staff, wherein the customized instructions detail exact times when to prepare each item in the order;
receive a check-in acknowledge from the customer;
send an alert to wait staff, the alert instructing wait staff to seat the customer;
receive a request to pay for the order; and
facilitate payment of the order.

2. The system of claim 1, wherein the database further comprises staff data, inventory data, sales data, and locality data.

3. The system of claim 2, wherein the locality data is updated by real-time feeds.

4. The system of claim 1, wherein the restaurant server facilitates bill splitting if there are two or more customers associated with the order.

5. The system of claim 1, further comprising an orders module, comprising a second plurality of programming instructions stored in the memory and operating on the processor, wherein the second plurality of programming instructions, when operating on the processor, causes the computer system to:
offer discounts on preferred items, wherein preferred items are based in part on the customer's profile.

6. The system of claim 5, wherein the preferred items are based in part on the inventory data.

7. The system of claim 5, wherein the preferred items are based in part on the sales data.

8. A method for end-to-end contactless dining experience and management, comprising the steps of:
receiving a customer's request for a reservation;
receiving an order associated with the reservation;
calculating an earliest arrival time for the customer, wherein the earliest arrival time is based on a scheduling algorithm, a waitlist algorithm, the profile of the customer, and the meal preparation time of the order;
sending the earliest arrival time to the customer;
receiving an acknowledgement confirming the earliest arrival time;
sending customized instructions to restaurant staff, wherein the customized instructions detail exact times when to prepare each item in the order;
receiving a check-in acknowledge from the customer;
sending an alert to wait staff, the alert instructing wait staff to seat the customer;
receiving a request to pay for the order; and
facilitating payment of the order.

9. The method of claim 8, wherein the database further comprises staff data, inventory data, sales data, and locality data.

10. The method of claim 9, wherein the locality data is updated by real-time feeds.

11. The method of claim 8, wherein the restaurant server facilitates bill splitting if there are two or more customers associated with the order.

12. The method of claim 8, further comprising an orders module, comprising a second plurality of programming instructions stored in the memory and operating on the processor, wherein the second plurality of programming instructions, when operating on the processor, causes the computer system to:
offer discounts on preferred items, wherein preferred items are based in part on the customer's profile.

13. The method of claim 12, wherein the preferred items are based in part on the inventory data.

14. The method of claim 12, wherein the preferred items are based in part on the sales data.
